(19) United States
(12) Patent Application Publication
(10) Pub. No.: US 2025/0220639 A1
(43) Pub. Date: Jul. 3, 2025

(54) MULTI-STAGE WAKEUP SIGNALING FOR PASSIVE DEVICES

(71) Applicant: QUALCOMM INCORPORATED, San Diego, CA (US)

(72) Inventors: Ahmed Elshafie, San Diego, CA (US); Huilin Xu, Temecula, CA (US); Yuchul Kim, San Diego, CA (US); Seyedkianoush Hosseini, San Diego, CA (US); Zhikun Wu, Beijing (CN); Linhai He, San Diego, CA (US)

(21) Appl. No.: 18/851,663

(22) PCT Filed: May 27, 2022
(86) PCT No.: PCT/CN2022/095462

§ 371 Date: Sep. 26, 2024

(51) Int. Cl. H04W 72/044; H04W 52/02; H04W 72/231; H04W 76/28

(52) U.S. Cl. CPC H04W 72/044; H04W 52/0235; H04W 72/231; H04W 76/28

(57) ABSTRACT

Methods, systems, and devices for wireless communications are described. The network may implement multi-stage energy handshake messages (e.g., wakeup indicators (WUIs and multi-stage wakeup notifications (WUNs))). The first-stage WUI and first-stage WUN may include minimal information (e.g., a sequence-based signal). Second stage WUIs may include an amount of data buffering for the UE, or an expected amount of time of communications during a next on duration. Second-stage WUNs may include confirmation that the UE 115 will receive the buffered data, or an indication of an amount of time required (e.g., a number of duty cycles or a number of seconds) to have enough energy to communicate. In some examples, the UE 115 may transmit WUNs prior to receiving WUIs. In some examples, the UE 115 may receive a multicast message prior to receiving a WUI.

### CROSS REFERENCE

The present application is a 371 national stage filing of International PCT Application No. PCT/CN2022/095462 by Elshafie et al. entitled “MULTI-STAGE WAKEUP SIGNALING FOR PASSIVE DEVICES,” filed May 27, 2022, which is assigned to the assignee hereof, and which is expressly incorporated by reference in its entirety herein.

### TECHNICAL FIELD

The following relates to wireless communications, including multi-stage wakeup signaling for passive devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multi-stage wakeup signaling for passive devices. The network may implement multi-stage energy handshake messages (e.g., wakeup indicators (WUIs and multi-stage wakeup notifications (WUNs)). The network may configure resources for first and second-stage WUIs, and first and second-stage WUNs, where each is configured with a repetition factor and periodicity. In some examples, the first-stage WUI and first-stage WUN may include minimal information (e.g., a sequence-based signal). If the UE 115 is capable of further communication during an on duration, it may indicate its capability using a first-stage WUN in response to a first-stage WUI. Second stage WUIs may include an amount of data buffering for the UE, an expected amount of time of communications during a next on duration. Second-stage WUNs may include confirmation that the UE 115 will receive the buffered data, or an indication of an amount of time required (e.g., a number of duty cycles or a number of seconds) to have enough energy to communicate. In some examples, the UE 115 may transmit WUNs prior to receiving WUIs. In some examples, the UE 115 may receive a multicast message prior to receiving a WUI.

A method for wireless communications at a user equipment (UE) is described. The method may include receiving control signaling indicating resources allocated to one or more energy handshake messages of a multi-stage energy handshake protocol between the UE and a wireless device, where the one or more energy handshake messages is associated with a repetition factor and a periodicity, transmitting or receiving the one or more energy handshake messages using the indicated resources and in accordance with the repetition factor and the periodicity, and transmitting or receiving data during one or more on periods of a discontinuous reception cycle based on the one or more energy handshake messages.

An apparatus for wireless communications at a UE is described. The apparatus may include at least one processor, and memory coupled to the at least one processor. The instructions may be executable by the at least one processor to cause the UE to receive control signaling indicating resources allocated to one or more energy handshake messages of a multi-stage energy handshake protocol between the UE and a wireless device, where the one or more energy handshake messages is associated with a repetition factor and a periodicity, transmit or receive the one or more energy handshake messages using the indicated resources and in accordance with the repetition factor and the periodicity, and transmit or receive data during one or more on periods of a discontinuous reception cycle based on the one or more energy handshake messages.

Another apparatus for wireless communications at a UE is described. The apparatus may include means for receiving control signaling indicating resources allocated to one or more energy handshake messages of a multi-stage energy handshake protocol between the UE and a wireless device, where the one or more energy handshake messages is associated with a repetition factor and a periodicity, means for transmitting or receiving the one or more energy handshake messages using the indicated resources and in accordance with the repetition factor and the periodicity, and means for transmitting or receiving data during one or more on periods of a discontinuous reception cycle based on the one or more energy handshake messages.

A non-transitory computer-readable medium storing code for wireless communications at a UE is described. The code may include instructions executable by a processor to receive control signaling indicating resources allocated to one or more energy handshake messages of a multi-stage energy handshake protocol between the UE and a wireless device, where the one or more energy handshake messages is associated with a repetition factor and a periodicity, transmit or receive the one or more energy handshake messages using the indicated resources and in accordance with the repetition factor and the periodicity, and transmit or receive data during one or more on periods of a discontinuous reception cycle based on the one or more energy handshake messages.

In some examples of the method, apparatuses, and non-transitory computer-readable medium described herein, transmitting or receiving the one or more energy handshake messages may include operations, features, means, or instructions for receiving the first-stage wakeup indication including a sequence-based request that the UE transmit the first-stage wakeup notification if a threshold energy level at the UE may be satisfied and transmitting, based on receiving the first-stage wakeup indication and the threshold energy level at the UE being satisfied, the first-stage wakeup notification including a sequence-based response to the first-stage wakeup indication indicating that the UE may be capable of waking up to perform additional communications.

In some examples of the method, apparatuses, and non-transitory computer-readable medium described herein, transmitting or receiving the one or more energy handshake messages may include operations, features, means, or instructions for receiving, based on transmitting the first-stage wakeup notification, the second-stage wakeup indication including an amount of data buffered for the UE and transmitting, based on receiving the second-stage wakeup indication, the second-stage wakeup notification including an indication of a number of cycles of the discontinuous reception cycle after which the UE may be capable of transmitting data or receiving the data buffered for the UE.

In some examples of the method, apparatuses, and non-transitory computer-readable medium described herein, transmitting or receiving the one or more energy handshake messages may include operations, features, means, or instructions for waking up after expiration of the number of cycles of the discontinuous reception cycle, receiving a second first-stage wakeup indication, transmitting, based on receiving the second first-stage wakeup indication, a second first-stage wakeup notification including a sequence-based response to the second first-stage wakeup indication indicating that the UE may be capable of waking up to perform additional communications, receiving, based on transmitting the second first-stage wakeup notification, a second second-stage wakeup indication, and transmitting, based on receiving the second second-stage wakeup indication, a second second-stage wakeup notification indicating that the UE may be capable of receiving the data buffered for the UE or transmitting data in a next on period of the discontinuous reception cycle.

In some examples of the method, apparatuses, and non-transitory computer-readable medium described herein, transmitting or receiving the one or more energy handshake messages may include operations, features, means, or instructions for waking up after expiration of the number of cycles of the discontinuous reception cycle, refraining from transmitting a second first-stage wakeup notification based on transmitting the second-stage wakeup notification, receiving, based on transmitting the second-stage wakeup indication including the indication of the number of cycles of the discontinuous reception cycle, a second second-stage wakeup indication, and transmitting, based on receiving the second second-stage wakeup indication, a second second-stage wakeup notification indicating that the UE may be capable of receiving the data buffered for the UE or transmitting data in a next on period of the discontinuous reception cycle.

Some examples of the method, apparatuses, and non-transitory computer-readable medium described herein may further include operations, features, means, or instructions for monitoring a set of one or more energy transfer resources for an energy transfer signal based on transmitting the second-stage wakeup notification and performing energy harvesting using the energy transfer signal, where transmitting the second-stage wakeup notification may be based on performing the energy harvesting.

Some examples of the method, apparatuses, and non-transitory computer-readable medium described herein may further include operations, features, means, or instructions for determining the number of cycles of the discontinuous reception cycle after which the UE may be capable of receiving the data buffered for the UE or transmitting data based on a default time value, a battery status, a pathloss, a target power, a buffer status report, an indication of a length of time for receiving the data buffered for the UE included in the second-stage wakeup indication, or any combination thereof.

Some examples of the method, apparatuses, and non-transitory computer-readable medium described herein may further include operations, features, means, or instructions for including, in the second-stage wakeup notification, an indication of a threshold time gap between a first message including an uplink message, a downlink message, or a sidelink message, and a second message including a downlink message, an uplink message, or a sidelink message, where the threshold time gap may be based on a type of channel associated with the first message, a type of channel associated with the second message, or both.

Some examples of the method, apparatuses, and non-transitory computer-readable medium described herein may further include operations, features, means, or instructions for receiving a downlink control information message including an instruction for a set of UEs including the UE to monitor for the first-stage wakeup indication, where receiving the first-stage wakeup indication may be based on receiving the downlink control information message.

Some examples of the method, apparatuses, and non-transitory computer-readable medium described herein may further include operations, features, means, or instructions for decoding, in the downlink control information message, a UE identifier associated with the UE, where receiving the instruction for the set of UEs to monitor for the first-stage wakeup indication may be based on decoding the UE identifier associated with the UE.

Some examples of the method, apparatuses, and non-transitory computer-readable medium described herein may further include operations, features, means, or instructions for receiving an indication of a set of resources on which the set of UEs may be to monitor for the downlink control information message, where receiving the downlink control information message may be based on monitoring the set of resources.

In some examples of the method, apparatuses, and non-transitory computer-readable medium described herein, the one or more energy handshake messages further include a second second-stage wakeup notification and the first-stage wakeup indication may be multicast, and the second-stage wakeup indication may be unicast.

In some examples of the method, apparatuses, and non-transitory computer-readable medium described herein, transmitting or receiving the one or more energy handshake messages may include operations, features, means, or instructions for receiving the first-stage wakeup indication including a sequence-based request that the UE transmit a first-stage wakeup notification if a threshold energy level at the UE may be satisfied, refraining from transmitting the first-stage wakeup notification based on the threshold energy level at the UE not being satisfied, and receiving the second first-stage wakeup indication after a threshold period of time based on refraining from transmitting the first-stage wakeup notification.

Some examples of the method, apparatuses, and non-transitory computer-readable medium described herein may further include operations, features, means, or instructions for receiving control signaling including an indication of the threshold period of time.

Some examples of the method, apparatuses, and non-transitory computer-readable medium described herein may further include operations, features, means, or instructions for determining the threshold period of time based on a power charging threshold sufficient for performing wireless communications during the one or more on periods of the discontinuous reception cycle.

Some examples of the method, apparatuses, and non-transitory computer-readable medium described herein may further include operations, features, means, or instructions for receiving a synchronization signal block corresponding to the resources allocated to the one or more energy handshake messages, where the control signaling indicating the resources includes a mapping between the synchronization signal block and the resources, and where transmitting or receiving the one or more energy handshake messages may be based on a determination of the resources based on the mapping.

Some examples of the method, apparatuses, and non-transitory computer-readable medium described herein may further include operations, features, means, or instructions for receiving, in the control signaling indicating the resources allocated to the one or more energy handshake messages, an indication of a timing offset between the first-stage wakeup indication and the first-stage wakeup notification, and the second-stage wakeup indication and the second-stage wakeup notification.

In some examples of the method, apparatuses, and non-transitory computer-readable medium described herein, transmitting or receiving the one or more energy handshake messages may include operations, features, means, or instructions for transmitting, based on a threshold energy level at the UE being satisfied, the first-stage wakeup notification including a sequence-based indication that the UE may be capable of waking up to perform additional communications and receiving, based on transmitting the first-stage wakeup notification, the first-stage wakeup indication responsive to the first-stage wakeup notification.

Some examples of the method, apparatuses, and non-transitory computer-readable medium described herein may further include operations, features, means, or instructions for transmitting or receiving data during the one or more on periods of the discontinuous reception cycle may be based on receiving the first-stage wakeup indication.

Some examples of the method, apparatuses, and non-transitory computer-readable medium described herein may further include operations, features, means, or instructions for transmitting, prior to expiration of an inactivity timer during the one or more on periods of the discontinuous reception cycle, an indication of UE capability in a next on period of the discontinuous reception cycle.

Some examples of the method, apparatuses, and non-transitory computer-readable medium described herein may further include operations, features, means, or instructions for receiving an energy transfer signal during the one or more on periods of the discontinuous reception cycle and based on receiving the first-stage wakeup notification.

Some examples of the method, apparatuses, and non-transitory computer-readable medium described herein may further include operations, features, means, or instructions for including, in the first-stage wakeup notification, an indication of a battery power level of the UE.

In some examples of the method, apparatuses, and non-transitory computer-readable medium described herein, transmitting the first-stage wakeup notification may include operations, features, means, or instructions for including the first-stage wakeup notification in a random access message, a service request, a scheduling request, a buffer status report, or a combination thereof.

Some examples of the method, apparatuses, and non-transitory computer-readable medium described herein may further include operations, features, means, or instructions for resetting a round trip time timer based on determining that an energy level at the UE does not satisfy a threshold or based on the UE transmitting an indication of an amount of time for harvesting an amount of energy that satisfies the threshold in one of the one or more energy handshake messages and continuing the round trip time timer during a next on period of the one or more on periods of the discontinuous reception cycle.

A method for wireless communications at a wireless device is described. The method may include outputting control signaling indicating resources allocated to one or more energy handshake messages of a multi-stage energy handshake protocol between the wireless device and a UE, where the one or more energy handshake messages is associated with a repetition factor and a periodicity, outputting or obtaining the one or more energy handshake messages using the indicated resources and in accordance with the repetition factor and the periodicity, and outputting or obtaining data during one or more on periods of a discontinuous reception cycle based on the one or more energy handshake messages.

An apparatus for wireless communications at a wireless device is described. The apparatus may include at least one processor, and memory coupled to the at least one processor. The instructions may be executable by the at least one processor to cause the wireless device to output control signaling indicating resources allocated to one or more energy handshake messages of a multi-stage energy handshake protocol between the wireless device and a UE, where the one or more energy handshake messages is associated with a repetition factor and a periodicity, output or obtain the one or more energy handshake messages using the indicated resources and in accordance with the repetition factor and the periodicity, and output or obtain data during one or more on periods of a discontinuous reception cycle based on the one or more energy handshake messages.

Another apparatus for wireless communications at a wireless device is described. The apparatus may include means for outputting control signaling indicating resources allocated to one or more energy handshake messages of a multi-stage energy handshake protocol between the wireless device and a UE, where the one or more energy handshake messages is associated with a repetition factor and a periodicity, means for outputting or obtaining the one or more energy handshake messages using the indicated resources and in accordance with the repetition factor and the periodicity, and means for outputting or obtaining data during one or more on periods of a discontinuous reception cycle based on the one or more energy handshake messages.

A non-transitory computer-readable medium storing code for wireless communications at a wireless device is described. The code may include instructions executable by a processor to output control signaling indicating resources allocated to one or more energy handshake messages of a multi-stage energy handshake protocol between the wireless device and a UE, where the one or more energy handshake messages is associated with a repetition factor and a periodicity, output or obtain the one or more energy handshake messages using the indicated resources and in accordance with the repetition factor and the periodicity, and output or obtain data during one or more on periods of a discontinuous reception cycle based on the one or more energy handshake messages.

In some examples of the method, apparatuses, and non-transitory computer-readable medium described herein, outputting or obtaining the one or more energy handshake messages may include operations, features, means, or instructions for outputting the first-stage wakeup indication including a sequence-based request that the UE transmit the first-stage wakeup notification if a threshold energy level at the UE may be satisfied and obtaining, based on outputting the first-stage wakeup indication and the threshold energy level at the UE being satisfied, the first-stage wakeup notification including a sequence-based response to the first-stage wakeup indication indicating that the UE may be capable of waking up to perform additional communications.

In some examples of the method, apparatuses, and non-transitory computer-readable medium described herein, outputting or obtaining the one or more energy handshake messages may include operations, features, means, or instructions for outputting, based on obtaining the first-stage wakeup notification, the second-stage wakeup indication including an amount of data buffered for the UE and obtaining, based on outputting the second-stage wakeup indication, the second-stage wakeup notification including an indication of a number of cycles of the discontinuous reception cycle after which the UE may be capable of transmitting data or receiving the data buffered for the UE.

In some examples of the method, apparatuses, and non-transitory computer-readable medium described herein, outputting or obtaining the one or more energy handshake messages may include operations, features, means, or instructions for outputting the second first-stage wakeup indication upon expiration of the number cycles of the discontinuous reception cycle, obtaining, based on outputting the second first-stage wakeup indication, a second first-stage wakeup notification including a sequence-based response to the second first-stage wakeup indication indicating that the UE may be capable of waking up to perform additional communications, outputting, based on obtaining the second first-stage wakeup notification, a second second-stage wakeup indication, and obtaining, based on outputting the second second-stage wakeup indication, a second second-stage wakeup notification indicating that the UE may be capable of receiving the data buffered for the UE or transmitting data in a next on period of the discontinuous reception cycle.

In some examples of the method, apparatuses, and non-transitory computer-readable medium described herein, outputting or obtaining the one or more energy handshake messages may include operations, features, means, or instructions for outputting, upon expiration of the number of cycles of the discontinuous reception cycle and based on obtaining the second-stage wakeup notification, a second second-stage wakeup indication and obtaining, based on outputting the second second-stage wakeup indication, a second second-stage wakeup notification indicating that the UE may be capable of receiving the data buffered for the UE or transmitting data in a next on period of the discontinuous reception cycle.

Some examples of the method, apparatuses, and non-transitory computer-readable medium described herein may further include operations, features, means, or instructions for outputting, via a set of one or more energy transfer resources, an energy transfer signal based on obtaining the second-stage wakeup notification.

In some examples of the method, apparatuses, and non-transitory computer-readable medium described herein, the number of cycles of the discontinuous reception cycles may be based on a default time value, a battery status, a pathloss, a target power, a buffer status report, an indication of a length of time for receiving the data buffered for the UE included in the second-stage wakeup indication, or any combination thereof.

Some examples of the method, apparatuses, and non-transitory computer-readable medium described herein may further include operations, features, means, or instructions for obtaining, in the second-stage wakeup notification, an indication of a threshold time gap between a first transmission and a second transmission, where the first transmission includes a downlink transmissions, an uplink transmissions, or a sidelink transmission, and where the second transmission includes a downlink transmission, an uplink transmission, or a sidelink transmission.

Some examples of the method, apparatuses, and non-transitory computer-readable medium described herein may further include operations, features, means, or instructions for outputting a downlink control information message including an instruction for a set of UEs including the UE to monitor for the first-stage wakeup indication, where outputting the first-stage wakeup indication may be based on outputting the downlink control information message.

Some examples of the method, apparatuses, and non-transitory computer-readable medium described herein may further include operations, features, means, or instructions for including, in the downlink control information message, a set of UE identifiers for the set of UEs, the set of UE identifiers including a UE identifier associated with the UE.

Some examples of the method, apparatuses, and non-transitory computer-readable medium described herein may further include operations, features, means, or instructions for outputting an indication of a set of resources on which the set of UEs may be to monitor for the downlink control information message.

In some examples of the method, apparatuses, and non-transitory computer-readable medium described herein, the one or more energy handshake messages further include a second second-stage wakeup notification and the first-stage wakeup indication may be multicast, and the second-stage wakeup indication may be unicast.

In some examples of the method, apparatuses, and non-transitory computer-readable medium described herein, transmitting or receiving the one or more energy handshake messages may include operations, features, means, or instructions for outputting the first-stage wakeup indication including a sequence-based request that the UE transmit a first-stage wakeup notification if a threshold energy level at the UE may be satisfied, monitoring for the first-stage wakeup notification based on outputting the first-stage wakeup indication, and outputting a second first-stage wakeup indication after a threshold period of time based on the monitoring.

Some examples of the method, apparatuses, and non-transitory computer-readable medium described herein may further include operations, features, means, or instructions for outputting control signaling including an indication of the threshold period of time.

Some examples of the method, apparatuses, and non-transitory computer-readable medium described herein may further include operations, features, means, or instructions for determining the threshold period of time based on a power charging threshold sufficient for performing wireless communications during the one or more on periods of the discontinuous reception cycle.

Some examples of the method, apparatuses, and non-transitory computer-readable medium described herein may further include operations, features, means, or instructions for outputting a synchronization signal block corresponding to the resources allocated to the one or more energy handshake messages, where the control signaling indicating the resources includes a mapping between the synchronization signal block and the resources, and where outputting or obtaining the one or more energy handshake messages may be based on a determination of the resources based on the mapping.

Some examples of the method, apparatuses, and non-transitory computer-readable medium described herein may further include operations, features, means, or instructions for outputting, in the control signaling indicating the resources allocated to the one or more energy handshake messages, an indication of a timing offset between the first-stage wakeup indication and the first-stage wakeup notification, and the second-stage wakeup indication and the second-stage wakeup notification.

In some examples of the method, apparatuses, and non-transitory computer-readable medium described herein, outputting or obtaining the one or more energy handshake messages may include operations, features, means, or instructions for obtaining, based on a threshold energy level at the UE being satisfied, the first-stage wakeup notification including a sequence-based indication that the UE may be capable of waking up to perform additional communications and outputting, based on obtaining the first-stage wakeup notification, the first-stage wakeup indication responsive to the first-stage wakeup notification.

Some examples of the method, apparatuses, and non-transitory computer-readable medium described herein may further include operations, features, means, or instructions for outputting or obtaining data during the one or more on periods of the discontinuous reception cycle may be based on outputting the first-stage wakeup indication.

Some examples of the method, apparatuses, and non-transitory computer-readable medium described herein may further include operations, features, means, or instructions for obtaining, prior to expiration of an inactivity timer during the one or more on periods of the discontinuous reception cycle, an indication of UE capability in a next on period of the discontinuous reception cycle.

Some examples of the method, apparatuses, and non-transitory computer-readable medium described herein may further include operations, features, means, or instructions for outputting an energy transfer signal during the one or more on periods of the discontinuous reception cycle and based on outputting the first-stage wakeup notification.

Some examples of the method, apparatuses, and non-transitory computer-readable medium described herein may further include operations, features, means, or instructions for obtaining, in the first-stage wakeup notification, an indication of a battery power level of the UE.

In some examples of the method, apparatuses, and non-transitory computer-readable medium described herein, obtaining the first-stage wakeup notification may include operations, features, means, or instructions for obtaining the first-stage wakeup notification in a random access message, a service request, a scheduling request, a buffer status report, or a combination thereof.

### BRIEF DESCRIPTION OF THE DRAWINGS

FIG. 1 illustrates an example of a wireless communications system that supports multi-stage wakeup signaling for passive devices in accordance with one or more aspects of the present disclosure.

FIG. 2 illustrates an example of an energy handshake scheme that supports multi-stage wakeup signaling for passive devices in accordance with one or more aspects of the present disclosure.

FIG. 3 illustrates an example of an energy handshake scheme that supports multi-stage wakeup signaling for passive devices in accordance with one or more aspects of the present disclosure.

FIG. 4 illustrates an example of an energy handshake scheme that supports multi-stage wakeup signaling for passive devices in accordance with one or more aspects of the present disclosure.

FIG. 5 illustrates an example of an energy handshake scheme that supports multi-stage wakeup signaling for passive devices in accordance with one or more aspects of the present disclosure.

FIG. 6 illustrates an example of an energy handshake scheme that supports multi-stage wakeup signaling for passive devices in accordance with one or more aspects of the present disclosure.

FIG. 7 illustrates an example of an energy handshake scheme that supports multi-stage wakeup signaling for passive devices in accordance with one or more aspects of the present disclosure.

FIG. 8 illustrates an example of an energy handshake scheme that supports multi-stage wakeup signaling for passive devices in accordance with one or more aspects of the present disclosure.

FIG. 9 illustrates an example of an energy handshake scheme that supports multi-stage wakeup signaling for passive devices in accordance with one or more aspects of the present disclosure.

FIG. 10 illustrates an example of a process flow that supports multi-stage wakeup signaling for passive devices in accordance with one or more aspects of the present disclosure.

FIGS. 11 and 12 show block diagrams of devices that support multi-stage wakeup signaling for passive devices in accordance with one or more aspects of the present disclosure.

FIG. 13 shows a block diagram of a communications manager that supports multi-stage wakeup signaling for passive devices in accordance with one or more aspects of the present disclosure.

FIG. 14 shows a diagram of a system including a device that supports multi-stage wakeup signaling for passive devices in accordance with one or more aspects of the present disclosure.

FIGS. 15 and 16 show block diagrams of devices that support multi-stage wakeup signaling for passive devices in accordance with one or more aspects of the present disclosure.

FIG. 17 shows a block diagram of a communications manager that supports multi-stage wakeup signaling for passive devices in accordance with one or more aspects of the present disclosure.

FIG. 18 shows a diagram of a system including a device that supports multi-stage wakeup signaling for passive devices in accordance with one or more aspects of the present disclosure.

FIGS. 19 through 23 show flowcharts illustrating methods that support multi-stage wakeup signaling for passive devices in accordance with one or more aspects of the present disclosure.

### DETAILED DESCRIPTION

In some wireless communications systems, a user equipment (UE), such as a passive internet of things (IoT) UE, may be capable of harvesting energy from solar energy, directional energy transfer signals from the network, or other sources. Such a UE may operate according to a duty cycle (e.g., a discontinuous reception (DRX) cycle), for example waking up during on durations of the duty cycle and entering a sleep mode during off durations of the duty cycle. However, the UE may waste power if it wakes up for on durations during which it has no uplink traffic to send or during which a network entity or sidelink UE has no traffic to transmit to the UE. The network and the UE may exchange energy handshake messages to conserve power and decrease system latency. The network may transmit a wakeup indicator (WUI) prior to an on duration, requesting the UE to activate an on duration if it has sufficient energy. The UE may respond with a wakeup notification (WUN) if it is able to wake up for communications during a next on duration of the duty cycle. However, in some examples, the UE may not be able to wake up to receive the WUI, or may not have sufficient energy to respond with a WUN, or may be able to transmit the WUN, but may expend limited power to receive the WUI and transmit the WUN (e.g., resulting in insufficient power for communications during the on duration itself).

Techniques described herein my support multi-phase energy handshake messages. The network may implement multi-stage WUIs and multi-stage WUNs. The network may configure resources for first and second-stage WUIs, and first and second-stage WUNs, where each is configured with a repetition factor and periodicity. In some examples, the first-stage WUI and first-stage WUN may include minimal information (e.g., a sequence-based signal). If the UE is capable of further communication during an on duration, it may indicate its capability using a first-stage WUN in response to a first-stage WUI. Second stage WUIs may include an amount of data buffering for the UE, or an expected amount of time of communications during a next on duration. Second-stage WUNs may include confirmation that the UE will receive the buffered data, or an indication of an amount of time (e.g., a number of duty cycles or a number of seconds) for the UE to have enough energy to communicate. In some examples, after the time passes, the UE may wake up again and receive another first-stage WUI or proceed to receive a second-stage WUI, and the first-stage WUI and WUN are ignored or canceled based on a previous second-stage WUN.

In some examples, the UE may transmit WUNs prior to receiving WUIs. This may allow the UE to avoid decoding WUIs and expending power unnecessarily if it has limited or no power for receiving WUIs. If there is data to be communicated during an on duration, then the UE may receive the data. If not, then the UE may replenish its energy supplies by receiving energy transfer signaling during the on duration.

In some examples, the UE may receive a multicast message prior to receiving a WUI. The multicast message may indicate a set of UEs that should partially wake up to receive a first-stage WUI. The first stage WUI may be multicast, and the second-stage WUI may be unicast to the UE.

Aspects of the disclosure are initially described in the context of wireless communications systems. Aspects of the disclosure are further illustrated by and described with reference to wireless communications systems, energy handshake schemes, and process flows. Aspects of the disclosure are further illustrated by and described with reference to apparatus diagrams, system diagrams, and flowcharts that relate to multi-stage wakeup signaling for passive devices.

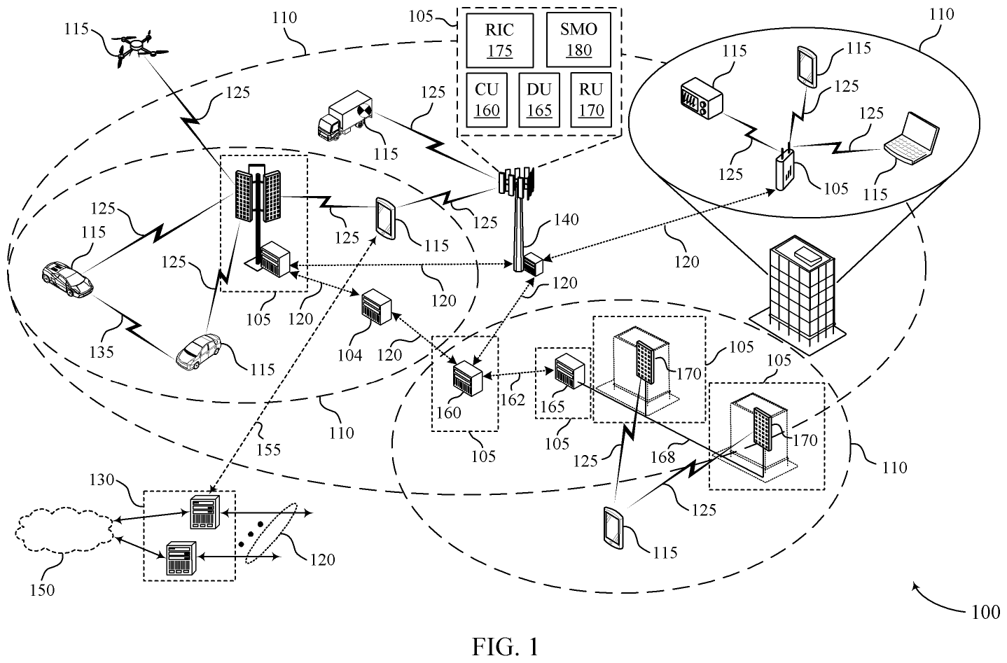

FIG. 1 illustrates an example of a wireless communications system 100 that supports multi-stage wakeup signaling for passive devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system, may include disclosure of the UE 115, network entity 105, apparatus, device, or computing system, being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multi-stage wakeup signaling for passive devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device, etc.), a camera, a gaming device, a navigation/positioning device (e.g., GNSS (global navigation satellite system) devices based on, for example, GPS (global positioning system), Beidou, GLONASS, or Galileo, or a terrestrial-based device, a tablet computer, a laptop computer, or a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), etc., and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

Techniques described herein my support multi-phase energy handshake messages. The network may implement multi-stage WUIs and multi-stage WUNs. The network may configure resources for first and second-stage WUIs, and first and second-stage WUNs, where each is configured with a repetition factor and periodicity. In some examples, the first-stage WUI and first-stage WUN may include minimal information (e.g., a sequence-based signal). If the UE 115 is capable of further communication during an on duration, it may indicate its capability using a first-stage WUN in response to a first-stage WUI. Second stage WUIs may include an amount of data buffering for the UE, or an expected amount of time of communications during a next on duration. Second-stage WUNs may include confirmation that the UE 115 will receive the buffered data, or an indication of an amount of time required (e.g., a number of duty cycles or a number of seconds) to have enough energy to communicate. After the time passes, the UE 115 may wake up again and either receive another first-stage WUI or may proceed to receive a second-stage WUI. If the UE 115 receives a second-stage WUI, the first-stage WUI and WUN may be ignored or canceled based on a previous second-stage WUN).

In some examples, the UE 115 may transmit WUNs prior to receiving WUIs. This may allow the UE 115 to avoid decoding WUIs and expending power unnecessarily if it has limited or no power for receiving WUIs. If there is data to be communicated during an on duration, then the UE 115 may receive the data. If not, then the UE 115 may replenish its energy supplies by receiving energy transfer signaling during the on duration.

In some examples, the UE 115 may receive a multicast message prior to receiving a WUI. The multicast message may indicate a set of UEs 115 that should partially wake up to receive a first-stage WUI. The first stage WUI may be multicast, and the second-stage WUI may be unicast to the UE 115.

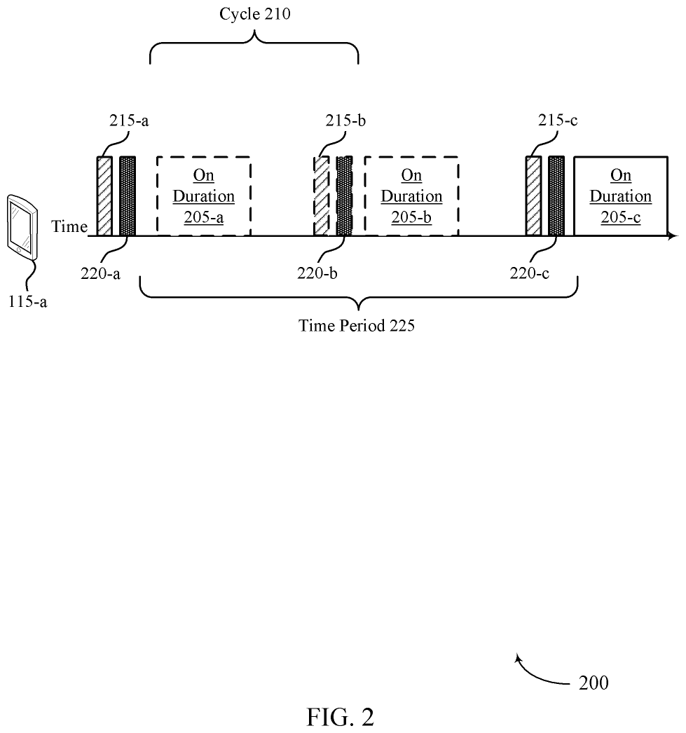

FIG. 2 illustrates an example of an energy handshake scheme 200 that supports multi-stage wakeup signaling for passive devices in accordance with one or more aspects of the present disclosure. In some examples, the energy handshake scheme 200 may implement, or be implemented by, aspects of wireless communications system 100. For example, the UE 115-a may communicate with another UE 115, or a network entity 105, which may be examples of corresponding devices described with reference to FIG. 1. The UE 115-a may communicate with a wireless device (e.g., a network entity 105, or a sidelink UE 115).

The UE 115-a may be an energy harvesting device (e.g., a reduced capacity (RedCap) UE), an enhanced RedCap (eRedCap) UE, a passive UE (PUE) in an IoT deployment, or a full capacity (e.g., non-RedCap) UE, among other examples. Energy harvesting devices, such as the UE 115-a, may opportunistically harvest energy from the environment. For example, the UE 115-a may harvest energy via backscattering, receiving energy transfer signaling from a network entity 105 (e.g., via a directional beam provided for the purpose of transferring energy to the UE 115-a), via solar energy transfer, heat energy transfer, or ambient radio frequency radiation. The UE 115-a may store such harvested energy (e.g., in a rechargeable battery). Some wireless communications systems may support energy harvesting protocols and energy handshake schemes. Such protocols may support operation (e.g., wireless communication) and energy harvesting on intermittently available energy harvested from the environment in which the UE 115-a is located. Variations in an amount of harvested energy for the UE 115-a may be expected over time, and in different scenarios (e.g., different traffic patterns for ambient radio frequency radiation, different times of day or night for solar energy harvesting, different charging capacity or rates at the UE 115-a, among other examples). Devices such as the UE 115-a operating on intermittently available energy harvested from the environment may not sustain long, or continuous reception or transmission operations.

The UE 115-a may be equipped with one or more power consuming radio frequency components such as ADC, mixers, or oscillators. The UE 115-a may support one or more transmit chains, and may tune transmit chains, energy harvesting circuitry, or both, to different frequency for wireless communications and energy harvesting. Energy harvesting wireless devices, such as the UE 115-a, may operate based on accumulated energy through an energy harvesting module. If accumulated energy is not sufficient to perform communications, then the UE 115-a may continue to accumulate energy over time. Until enough energy is accumulated by the UE 115-a for performing wireless communication, the UE 115-a may not be reachable by the network (e.g., by the wireless device such as a sidelink UE 115 operating in mode 1, or a network entity 105). Because energy harvesting availability and rate may be unpredictable, communication quality between an energy harvesting device such as the UE 115-a and the network may also be unpredictable or intermittent. Techniques described herein may support a wireless protocol that can support reliable communications between the UE 115-a and the network.

The UE 115-a may be configured (e.g., by the wireless device) to operate according to a duty cycle (e.g., a discontinuous reception (DRX) cycle). Such operations may support power saving at the UE 115-a. When operating under a duty cycle, the UE 115-a may wake up periodically to send and receive transmissions, and may go to sleep (e.g., enter an inactive mode, sleep mode, idle mode, or partially asleep mode) between on durations. For instance, for each cycle 210 of the duty cycle, the UE may enter an active mode (e.g., wake up) for wireless communication during one on duration 205. The UE may perform wireless communication during on durations 205, and may conserve power and/or harvest energy between on durations 205.

In some examples, the wireless device (e.g., the network) may not assume that the UE 115-a has sufficient energy to be available during each on duration 205 of the duty cycle. For example, the UE 115-a may be able to communicate during on duration 205-a, but may deplete its power stores during on duration 205-a. The UE 115-a may not be able to harvest sufficient energy during a cycle 210 to be ready for additional transmission or reception during on duration 205-b. Thus, the UE 115-a may be unavailable for wireless communication during on duration 205-b, but may once again have sufficient power for data transmission or reception during on duration 205-c. Any transmissions sent during an on duration 205 during which the UE 115-a is in an off or sleep state (e.g., the on duration 205-b) may be lost (e.g., resulting in retransmissions, increased latency, or inefficient use of system resources). The wireless device (e.g., the network entity 105) may save power by taking into account a status (e.g., energy level or availability) of the UE 115-a into account. In such examples, the network and the UE 115-a may communicate to determine whether the UE 115-a has enough accumulated energy (e.g., via energy harvesting and storage over time) for data transmission or reception during a given on duration.

The UE 115-a may support an energy handshake (EHS) protocol for performing energy transfer and efficient communications during a duty cycle. EHS protocols may enable the network to transmit and receive data with the UE 115-a when the UE 115-a has enough energy for wireless communication (e.g., and avoid failed communications during on durations 205 in which the UE 115-a is unavailable). Such protocols and techniques described herein may support reliable communications between the wireless device (e.g., a network entity 105 or a sidelink UE 115) and the UE 115-a, and may prevent the network from using radio resources unnecessarily.

EHS signaling may include one or more wakeup indications (WUIs) 215, one or more wakeup notifications (WUNs) 220, or a combination thereof. A WUI 215 may be sent by the wireless device to the UE 115-a, and may request information regarding whether the UE 115-a has enough energy to wake up and receive data or transmit data during one or more subsequent on durations. In some examples, a WUI 215 may indicate that the wireless device has data pending for transmission to the UE 115-a. A WUN 220 may be sent from the UE 115-a to the wireless device, to notify the wireless device (e.g., the network entity 105) as to whether the UE 115-a has sufficient energy for wireless communications in one or more subsequent on durations. For example, in response to receiving the WUI 215-a, the UE 115-a may transmit a WUN 220-a. The UE 115-a may indicate, in the WUN 220-a, that it has sufficient energy for data transmission or reception during the on duration 205-a, in which case the UE 115-a may wake up during the on duration 205-a and perform wireless communications with the wireless device. In some examples, the UE 115-a may indicate, in the WUN 220-a, that it will continue to sleep and harvest energy until an indicated time (e.g., upon expiration of time period 225). In some examples, time period 225 may have a fixed duration, a configured duration, or a variable duration indicated by the UE 115-a (e.g., in the WUN 220-a). In If the UE 115-a indicates, in the WUN 220-a that it does not have sufficient energy for wireless communications until after time period 225, then the UE 115-a may go to sleep until expiration of time period 225. In such examples, the UE 115-a may not wake up during on duration 205-a, or on duration 205-b. The UE 115-a may instead harvest energy during time period 225 (e.g., via energy transfer wireless signaling, solar energy harvesting, heat energy harvesting, among other examples).

In some example, WUIs 215 and WUNs 220 may be communicated prior to on durations 205 (e.g., the UE 115-a may enter a partially awake, or low power mode to communicate WUIs 215 and WUNs 220), and the UE 115-a may communicate data (e.g., larger amounts of data) during on durations 205. For example, the wireless device may transmit a WUI 215 prior to configured on durations 205 to determine whether the UE 115-a can wake up and receive data during a next on duration 205, or not. The timing of WUIs 215 may be preconfigured between the wireless device (e.g., a network entity 105 or a sidelink UE 115) and the UE 115-a.

The UE 115-a may receive the WUI 215 may determine whether to receive or decode a WUI 215. The UE 115-a may receive and decode a WUI 215 if it has energy to do so. For example, the UE 115-a may determine that it has sufficient energy to receive the WUI 215-b (e.g., despite not having sufficient energy for wireless communications of data during the on duration 205-b). In some cases, the UE 115-a may transmit a WUN 220-b (e.g., responsive to the WUI 215-b), indicating that the UE 115-a does not have sufficient power to communicate during the on duration 205-b. In some examples, the UE 115-a may skip receiving and decoding a WUI 215 in case the UE 115-a determines that it does not have enough energy accumulated to do so. For example, the UE 115-a may refrain from receiving the WUI 215-b while performing energy harvesting during the time period 225.

IN cases in which the UE 115-a receives a WUI 215, the UE 115-a may determine whether to send a WUN 220. The UE 115-a may skip sending a WUN 220 even after it correctly receives a WUI 215. For example, the UE 115-a may receive the WUI 215-b, but may determine that it has not accumulated enough energy to transmit the WUN 220-b. In some examples, the UE 115-a may avoid frequency wakeups. In such examples (e.g., for delay tolerant traffic), the UE 115-a may perform less-frequent wakeups and/or deferred reception, which may result in power savings. For instance, the UE 115-a may refrain from transmitting a WUN 220-b to conserve power for wireless communications during the on duration 205-c (e.g., after receiving the WUI 215-c and transmitting the WUN 220-c). The UE 115-a may transmit a WUN 220 to indicate (e.g., to the network) that the UE 15-a will wake up and be ready for wireless communications, or that the UE 15-a will not wake up for a next on duration 205 (e.g., for a number of seconds or a number of cycles 210) for further energy harvesting (e.g., which may allow the network to skip sending a WUI to the UE 115-a for the indicated duration, saving network resources).

The UE 115-a may enter and exit various charging states during the duty cycle. Charging states may be defined based on charging status and/or energy level at the UE 115, and UE behavior may be different in each charging state. For example, the UE 115-a may support in a full charged state. In a full charged state, the UE 115-a may be full charged, and capable of performing regular operations (e.g., PDCCH monitoring for downlink data reception, uplink transmissions, sending energy level notifications, such as WUNs 220, to the network, among other examples). When the UE 115-a is in a full charged state, the UE 115-a may wake up during on durations 205, but the UE 115-a may skip on durations 205 based on receiving (e.g., or skipping) WUIs 215. The UE 115-a may support one or more partially charged states. In a partially charged state, the UE 115-a may not support data communication between the network (e.g., via the wireless network) and the UE 115-a. However, the UE 115-a may communicate with the network about its charging status, charging time, or expected wakeup time (e.g., via WUNs 220). Supported operations in a partially charged state may include receiving WUIs 215, skipping monitoring of WUIs 215, transmitting WUNs 220, skipping sending of WUNs 220. The UE 115-a may skip on durations 205 when operating in a partially charged state. The UE 115-a may support more than one partially charged state, and UE capability within each partially charged state may vary. The UE 115-a may operate in a low charging state. When the UE 115-a is in a low charging state, the UE 115-a may not be reachable from the network due to a low energy level. In a low charging state, the UE 115-a may not be able to perform data transmission or reception, may not receive WUIs 215 or transmit WUNs 220, but may perform energy harvesting. The UE 115-a may also sip on durations 205 when in a low charging state.

Techniques described herein provide for efficient designs of uplink and sidelink EHSs, such as unicast WUIs 215, unicast WUNs 220, groupcast WUIs, among other examples. In some examples, techniques described herein may support multi-stage designs for WUIs 215 and WUNs 20. Multi-stage energy handshake protocols may support easy decoding of at least some WUI information, and easy transmission with low power and high reliability of at least some WUN information (e.g., a single bit transmitted in a first stage, and second stage with additional information).

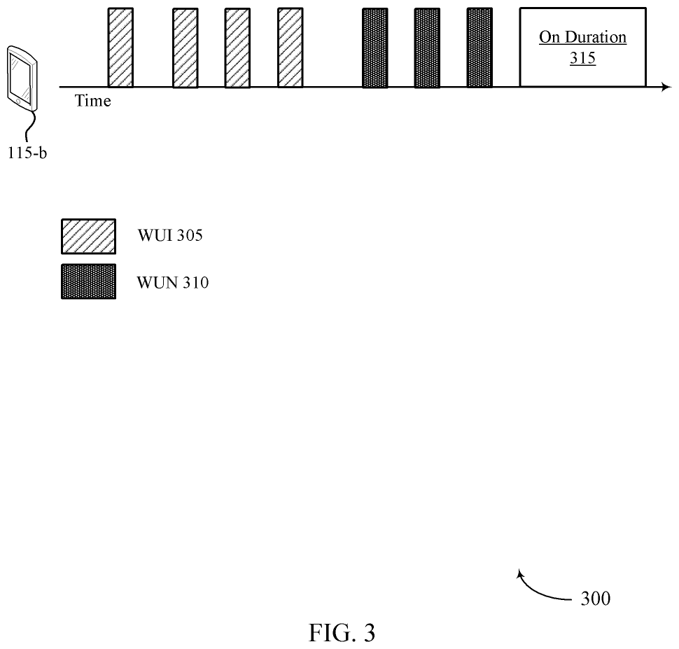

FIG. 3 illustrates an example of an energy handshake scheme 300 that supports multi-stage wakeup signaling for passive devices in accordance with one or more aspects of the present disclosure. In some examples, the energy handshake scheme 300 may implement, or be implemented by, aspects of wireless communications system 100, and energy handshake scheme 300. For example, the UE 115-b may communicate with another UE 115, or a network entity 105, which may be examples of corresponding devices described with reference to FIG. 1. The UE 115-a and a wireless device (e.g., a network entity 105, or a sidelink UE 115) may perform techniques described herein.

The network (e.g., via the wireless device) may configure a UE with certain occasions to activate on durations 315 of a duty cycle. The occasions may include resources (e.g., time-frequency resources) on which the UE is to receive WUIs, transmit WUNs, or both. Such occasions may be configured (e.g., or defined in one or more standards documents) for a Uu link (e.g., between the UE and the wireless device, where the wireless device is a network entity 105) or for sidelink to be used between UEs (e.g., where the wireless device is another sidelink UE). For sidelink, the occasions for WUIs and WUNs may be agreed (e.g., negotiated between sidelink UEs) using PC5 RRC signaling, MAC-CE signaling, sidelink control information (SCI) signaling, or a dedicated physical sidelink shared channel.

The UE may identify the occasions for receiving WUIs 305, and transmitting WUNs 310. In some examples, the occasion may include multiple occasions for WUIs 305, and multiple occasions for WUNs 310. In such examples, the UE may receive one or more repetitions of a WUI 305 on the resources allocated for repetitions of WUIs 305, and may transmit one or more repetitions of a WUN 310 on the resources allocated for repetitions of the WUN 310. In some examples, resources for repetitions of a WUI 305 and a WUN 310 may be located prior to on durations 315 of a duty cycle. In some examples, resources for repetitions of a WUI 305 and a WUN 310 maybe located during a portion (e.g., a first portion) of an on duration 315 of the duty cycle.

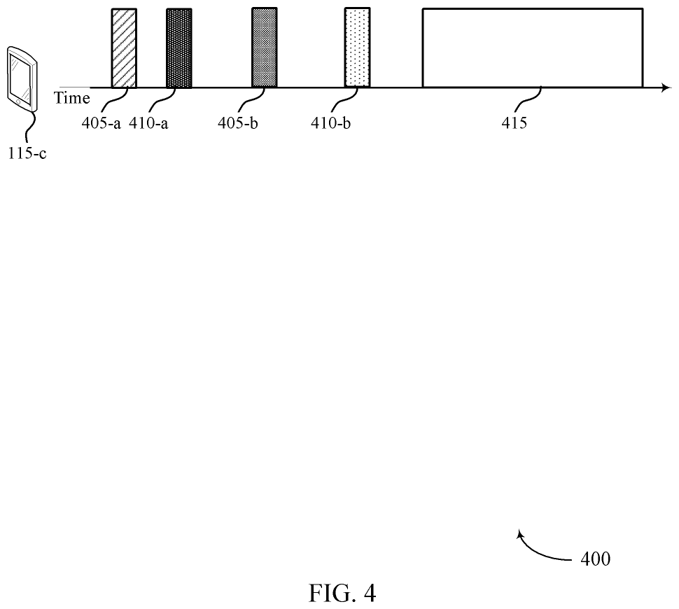

In some examples, as described in greater detail with reference to FIG. 4, the UE may perform multi-stage WUI 305 signaling and multi-stage WUN 310 signaling.

The UE may identify occasions for receiving multiple repetitions of a first stage WUI 305, occasions for transmitting multiple repetitions of a first-stage WUN 310, and/or may identify occasions for receiving multiple repetitions of a second-stage WUI 305, and occasions for transmitting multiple repetitions of a second-stage WUN 310. Techniques described throughout, including with reference to FIGS. 2-10, may include transmitting and receiving repetitions of first or second stage WUIs 305 and WUNs 310, as described with reference to FIG. 3.

FIG. 4 illustrates an example of an energy handshake scheme 400 that supports multi-stage wakeup signaling for passive devices in accordance with one or more aspects of the present disclosure. In some examples, the energy handshake scheme 400 may implement, or be implemented by, aspects of wireless communications system 100, energy handshake scheme 200, and energy handshake scheme 300. For example, the UE 115-c may communicate with another UE 115, or a network entity 105, which may be examples of corresponding devices described with reference to FIG. 1. The UE 115-c and a wireless device (e.g., a network entity 105, or a sidelink UE 115) may perform techniques described herein.

The UE 115-c may perform multi-stage energy handshake message signaling. Energy handshake messages may include WUIs 405 and WUNs 410. First-stage energy handshake messages may be successfully received or transmitting using a very low power (e.g., in a partially charged or low power state). Additional information may be communicated (e.g., in a higher partially charged state or full power state) in second-stage energy handshake messages. In some examples, first-stage energy handshake messages may be one-bit messages, or may be sequence based signals (e.g., with a binary bit design).

For example, the UE 115-c may receive, from the wireless device, a first-stage WUI 405-a, and may transmit a first-stage WUN 410-a. The first-stage WUI 405-a may be a one-bit or sequence based message requesting the UE 115-c to transmit a first-stage WUN 410-a, or requesting whether the UE 115-a is capable of transmitting the first-stage WUN 410-a and/or activating the on duration 415. Based on the first-stage WUN 410-a, the UE 115-c may receive, from the wireless device, a second-stage WUI 405-b. The second-stage WUI 405-b may include an indication of an amount of data for the UE buffered at the network. The UE 115-a may transmit, responsive to the second-stage WUI 405-b, a second-stage WUN 410-b. The second-stage WUN 410-b may include an amount of time (e.g., a number of seconds, or a number of cycles of the duty cycle) that the UE 115-c may skip for energy accumulation (e.g., an amount of time during which the UE 115-c will perform energy harvesting before being able to perform wireless communications during an on duration 415). Resources on which to transmit or receive one or more repetitions of energy handshake messages may be configured or negotiated prior to on durations 415, or during on durations 415. For instance, first-stage energy handshake messages may be communicated prior to on durations 415, and second-stage energy handshake messages may be communicated prior to on durations 415 (e.g., in a low power state or partially charged state) or may be communicated during an on duration 415 (e.g., in an awake mode or a full charged state).

In some examples, the UE 115-c may indicate, in the first-stage WUN 410-a, that it is capable of receiving second-stage WUI 405-b or transmitting a second-stage WUN 410-b. For instance, the UE 115-c may indicate a zero in a one-bit first-stage WUN 410-a. In such examples, the wireless device may assume that the UE 115-c is able to communicate, and will transmit the second-stage WUN 410-b. The wireless device may transmit the second-stage WUI 405-b, and monitor the appropriate resources for the second-stage WUN 410-b. If the wireless device does not receive the second-stage WUN 410-b, then the wireless device may determine that the UE 115-c does not have enough power to transmit the second-stage WUN 410-b and/or to communicate during the on duration 415. In such examples, the UE 115-c may attempt further communications with the wireless device after a time period (e.g., X) has expired. The time period may be preconfigured or a configured parameter (e.g., configured by the network via control signaling, such as RRC signaling, a MAC-CE, or DCI signaling). In some examples, the UE 115-c may have sufficient power to transmit a second-stage WUN 410-b (e.g., but not sufficient power to communicate during the on duration 415). In such examples, the UE 115-c may include, in the second-stage WUN 410-b, an indication of an updated time period (e.g., an updated or remaining amount of time after which the UE 115-c will have sufficient power to communicate with the wireless device).

In some examples, a set of wireless resources on which to communicate energy handshake messages (e.g., initial units of defined time and frequency resources) may be defined in one or more standards documents. In some examples, the set of wireless resources on which to communicate energy handshake messages may be configured using RRC signaling, a MAC-CE message, DCI signaling, or any combination thereof. In some examples, the set of wireless resources on which to communicate energy handshake messages (e.g., multi-stage energy handshake messages) may include resources for transmitting or receiving one or more repetitions of energy handshake messages according to a configured or predefined periodicity and repetition factor. The set of wireless resources may include a set of resource blocks, where symbols may be dedicated to WUIs 405 and WUNs 410 for each stage. In some examples, the set of wireless resources may be a function of an SSB beam index. For example, the UE 115-c may receive one or more SSBs, perform one or more measurements, and determine a best or preferred SSB. The UE 115-c may select the set of wireless resources mapped to the preferred SSB on which to perform the energy handshake message signaling. The mapping between the set of wireless resources and the various SSB indices may be configured via system information (e.g., system information block 1 (SIB1), system information block 2 (SIB2), other SIB (OSIB), or a random access message (e.g., a random access message 1 (msg2) or a random access message 4 (msg4) of a four-step random access message, or random access message B (msgB) or a two-step random access process), or other control signaling (e.g., RRC signaling, a MAC-CE, DCI signaling, or a combination thereof). In some examples, the mapping may be included in or more standards documents.

In some examples, timing between stages of WUIs 405 and WUNs 410 may be configured (e.g., via RRC signaling or MAC-CE), or may be preconfigured and loaded at the UE 115-c (e.g., defined in one or more standards documents). Initial timing values between the stages of the WUIs 405 and WUNs 410 may be updated over time (e.g., via RRC signaling, MAC-CE, DCI signaling, or a combination thereof).

In some examples, the UE 115-c may indicate that it will not wake up by refraining from transmitting a message (e.g., a first-stage WUN 410-a or a second-stage WUN 410-b). If the UE 115-c does not transmit a WUN 410, then the wireless device may determine that the UE 115-c is not ready to receive data. For example, the UE 115-c may not have sufficient energy, and may refrain from transmitting the first-stage WUN 410-a, indicating that it will not receive the second-stage WUI 405-b, or communicate during the on duration 415. In some examples, the UE 115-c may not have sufficient power to continue communications with the wireless device, but the UE 115-c may have sufficient power to transmit a first-stage WUN 410-a. The second-stage WUI 405-b may indicate an amount of data pending for the UE 115-c. If the UE 115-c does not have sufficient energy to receive the indicated amount of data, the UE 115-c may refrain from transmitting a second-stage WUN 410-b, indicating that it is not able to receive the indicated amount of data. Thus, a WUN 410 transmitted may indicate that it can wake up for subsequent communication, and an untransmitted WUN 410 may indicate that the UE 115-c will not wake up for subsequent communication.

In some examples, one or more wakeup messages, such as WUIs 405 (e.g., first or second stage WUIs 405) or WUNs 410 (e.g., first or second stage WUNs 410), or any combination thereof, may include additional information. A wakeup message such as a WUI 405 or a WUN 410 (e.g., a second-stage WUI 405-b) may include an indication that the UE 115-c is to wake up for data reception, an amount of data for the UE 115-c buffered at the network, an indication of a pathloss (e.g., a most recent or most recently updated value) to be used for uplink power allocation (e.g., uplink assistance information), an indication of one or more reference signals to assist the UE 115-c to determine a pathloss value (e.g., or the UE 115-c may rely on SSB reception and measurements, such as PSS, SSS, PBCH, or DMRS signals to estimate a pathloss), or any combination thereof.

A wakeup message such as a WUI 405 or a WUN 410 (e.g., a second-stage WUN 410) may include an indication, to the network, of when the UE 115-c will wake up (e.g., that the UE 115-c can wake up in a current cycle or current or next on duration), an indication that the UE 115-c cannot wake up during a current cycle, an indication of a threshold amount of data (e.g., a threshold number of transport blocks or bits) that the UE 115-c is able to decode during a current on duration (e.g., a cost may be associated with each transport block reception or transmission indicated by the UE 115-c, such as a cost for a unit of a PDSCH, a PDCCH, a PUSCH, a PUCCH, a PSSCH, a PSCCH, etc.), or any combination thereof. In some examples, one or more wakeup messages may include an indication of BSR (an uplink BSR, or a sidelink BSR reported between sidelink UEs 115 or a sidelink BSR report transmitted from one sidelink UE 115 to the network for sidelink resource allocation), an indication of transport block sizes, or a combination. For example, a threshold transmission power may be determined based on an initial power, pathloss, bandwidth (e.g., a number of RBs per symbol). For example, assuming a number of RBs M and a number of OFDM symbols for transmitting a transport block, then a number of resource elements (REs) may be the product of 12·M·N (e.g., and additionally any resources for DMRSs). A total power for transmitting the transport block may be the product of N and a threshold power. Allocation sizes or transmission MCS may be determined based on transport block size. The UE 115-c may indicate a fixed per-symbol power (e.g., regardless of pathloss), and may transmit with a preferred threshold power based on which the network may allocated a number of Res for transport block transmissions. Given the energy status at the UE 115-c, the UE 115-c may determine a BSR (an uplink BSR, or a sidelink BSR reported between sidelink UEs 115 or a sidelink BSR report transmitted from one sidelink UE 115 to the network for sidelink resource allocation), or a number of transport blocks to indicate to the network. Any of the described computations or techniques may be reused. In some examples, the UE 115-c may indicate, in one or more wakeup messages, a number of cycles that the UE 115-c may skip for energy accumulation (e.g., for performing energy harvesting). The network may utilize such information to avoid unnecessary data buffering, to inform other devices that the energy harvesting UE 115-c is not available or reachable during a time duration (e.g., a number of cycles or a number of seconds).

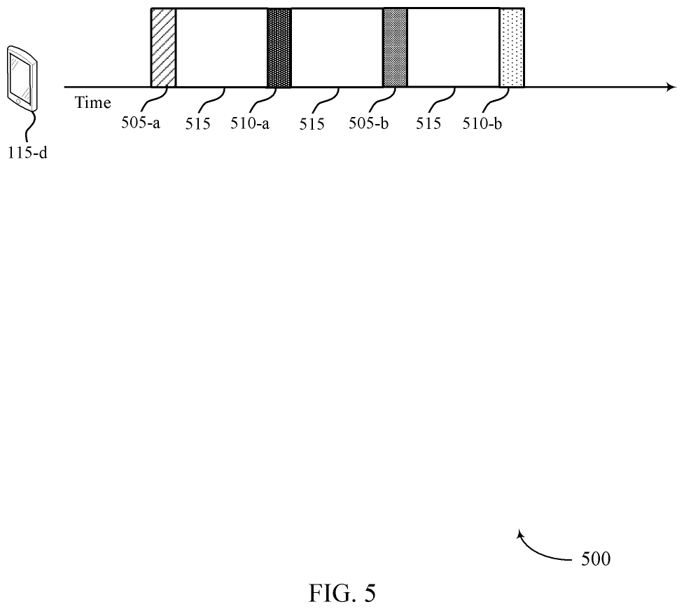

FIG. 5 illustrates an example of an energy handshake scheme 500 that supports multi-stage wakeup signaling for passive devices in accordance with one or more aspects of the present disclosure. In some examples, the energy handshake scheme 500 may implement, or be implemented by, aspects of wireless communications system 100, energy handshake scheme 200, energy handshake scheme 300, and energy handshake scheme 400. For example, the UE 115-d may communicate with another UE 115, or a network entity 105, which may be examples of corresponding devices described with reference to FIG. 1. The UE 115-d and a wireless device (e.g., a network entity 105, or a sidelink UE 115) may perform techniques described herein.

In some examples, if the UE 115-d is able to wake up, and have energy harvesting capability (e.g., radio frequency or wireless energy harvesting capability), the UE 115-d may perform energy harvesting between transmitting and receiving energy handshake messages (e.g., such as WUIs 505 and WUNs 510). In some examples, the wireless device (e.g., a network entity 105 such as the wireless device or another power source) may send beamformed powering signals (e.g., energy transfer signals) to further boost power at the UE 115-d before additional energy handshake messages are communicated (e.g., before receiving second-stage WUI 505-b or transmitting second-stage WUN 510-b, which may include more data than first-stage energy handshake messages, and may therefore use more energy). In some examples, the UE 115-c may monitor energy transfer resources and receive energy transfer signals between energy handshake messages (e.g., between first-stage WUI 505-a and first-stage WUN 510-b, between first-stage WUN 505-b and second-stage WUI 505-b, and between second-stage WUI 505-b and second-stage WUN 510-b), or prior to a coming grant or on duration. The UE 115-d may receive energy transfer signals 515 which may be dedicated, beamformed energy signals. Such energy transfer signals 515 may be transmitted from the wireless device (e.g., network entity 105) with which the UE 115-d is communicating the energy handshake messages, or may be transmitted from another network entity 105, or one or more dedicated source terminals or nodes (e.g., nodes allocated for transmitting energy transfer signals 515 for boosting energy at energy harvesting UEs 115).

In some examples, the UE 115-c may determine resources on which to monitor for energy transfer signals 515. Such features may be configured via layer 1 signaling, layer 2 signaling, layer 3 signaling, or any combination thereof (e.g., via RRC signaling, MAC-CE, or DCI signaling, or SCI signaling in sidelink between UEs 115), or may be configured via system information or random access messages (e.g., during initial access procedures using msg2, msg4, msgB, or MIB, SIB1, SIB2, or OSIB)., or in previous second-stage WUIs 505 (e.g., a second-stage WUI 505-b may indicate whether the energy harvesting feature is continued on or off). In some examples, resources or protocols for receiving energy harvesting signals 515 between or after handshake messages may be defined in one or more standards documents and preloaded at the UE 115-d. In some examples, the configuration of resources for receiving the energy transfer signals 515 may include an indication of or a mapping to one or more beam indices or device indicators (e.g., indicating to the UE 115-d whether it should monitor the beam on which it is communicating with the wireless device to receive the energy transfer signals 515, or whether the UE 115-d should orient a beam in a different direction toward a dedicated source node for the energy transfer signals 515).

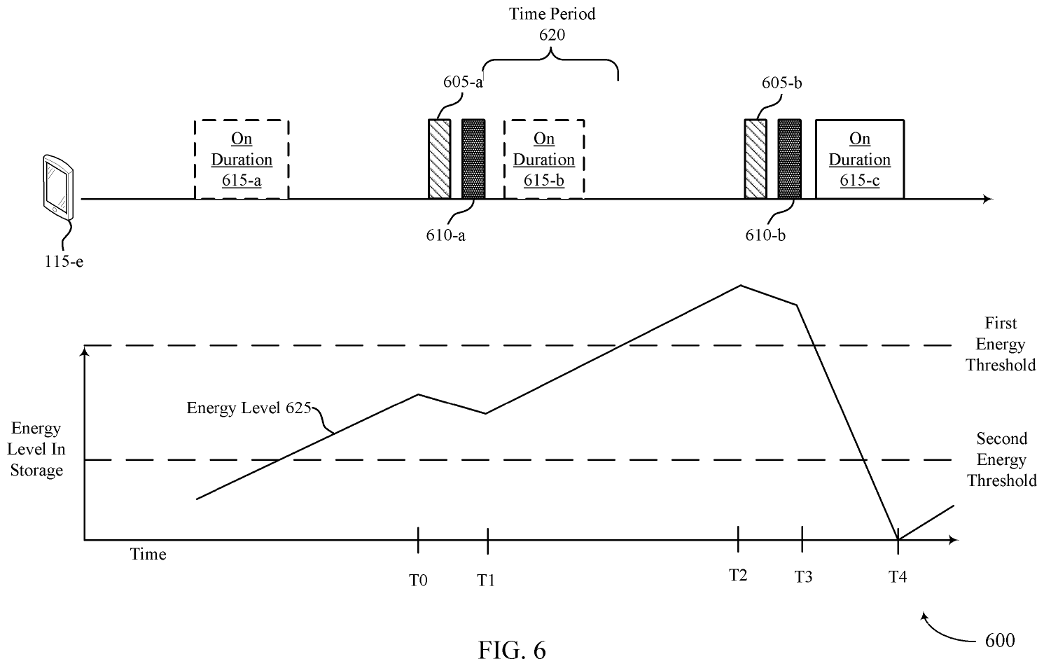

FIG. 6 illustrates an example of an energy handshake scheme 600 that supports multi-stage wakeup signaling for passive devices in accordance with one or more aspects of the present disclosure. In some examples, the energy handshake scheme 600 may implement, or be implemented by, aspects of wireless communications system 100, energy handshake scheme 200, energy handshake scheme 300, energy handshake scheme 400, and energy handshake scheme 500. For example, the UE 115-e may communicate with another UE 115, or a network entity 105, which may be examples of corresponding devices described with reference to FIG. 1. The UE 115-e and a wireless device (e.g., a network entity 105, or a sidelink UE 115) may perform techniques described herein.

The UE 115-e may operate according to an energy level 625. The UE 115-e may harvest energy (e.g., during time periods between on durations 615, as described in greater detail with reference to FIG. 5). When performing wireless communications, the UE 115-e may discharge its stored energy reserves, and the energy level 625 may decrease. In some examples, the UE 115-e may discharge energy faster in a full charged state or in a fully awake mode than in a partially charged state or a partially awake mode. If the energy level 625 is charged above a first energy threshold, then the UE 115-e may perform wireless communications such as data communications during an on duration 615 (e.g., may operate in a full charged state). If the energy level 625 is at or above the second energy threshold, but below the first energy threshold, then the UE 115-e may support sending WUNs 610 (e.g., but not data communications during on durations 615).

The UE 115-e may send an indication (e.g., in a WUN 610) of an amount of power (e.g., an amount of energy needed for data communications, a current energy level 625 or a difference between an energy level 625 and the first energy threshold, among other examples), or a duration of time (e.g., time period 620) before which the UE 115-e will achieve an energy level 625 that satisfies the first energy threshold (e.g., a time period 620 after which the UE 115-e will achieve full charge state). If the UE 115-e performs energy harvesting use solar energy or other non-signaling energy types, or if the UE 115-e is not being charged using wireless resources, then the indication in the WUN 610 may include a remaining charging time or waiting time (e.g., time period 620) prior to the UE 115-e being capable of starting wireless communications. Based on the indication of the time period 620, the wireless device (e.g. a network entity 105) may not expect the UE 115-e to wake up for wireless communications until after time period 620.

For example, the UE 115-e may have an energy level 625 that is lower than the second energy threshold prior to and/or during on duration 615-a. In such examples, the UE 115-e may not communicate during the on duration 615-a. Prior to on duration 615-b, the UE 115-e may perform energy harvesting, and may increase the energy level 625 to satisfy the second energy threshold (e.g., but not the first energy threshold). At time T0, the UE 115-e may receive a WUI 605-a (e.g., a second-stage WUI 605-a), which may indicate an amount of data pending for the UE 115-e, or other information. The UE 115-e may transmit a WUN 610-a (e.g., a second-stage WUN 610-a), which may include an indication of the time period 620. The UE 115-e may discharge (e.g., the energy level 625 may decrease) between T0 and T1 while communicating energy handshake messages. However, having transmitted the indication of the time period 62, the UE 115-e may continue to charge during on duration 615-b. Upon expiration of time period 620, the UE 115-e may enter a full charged state (e.g., energy level 625 may satisfy the first energy threshold). The UE 115-e may continue to charge prior to on duration 615-c. At T3, the UE 115-e may successfully communicate with the wireless device, and may discharge (e.g., the energy level 625 may decrease). At T4 (e.g., after communicating during the on duration 615-c), the UE 115-e may have no charge left (e.g., energy level 625 may be low, or at zero, and may fail to satisfy the second energy threshold). The UE 115-e may then continue to perform energy harvesting, increasing energy level 625 in preparation for subsequent communications.

In some examples, having increased the energy level 625 to satisfy the first energy threshold, the UE 115-e may transmit and receive energy handshake messages upon expiration of time period 620. In such examples, the UE 115-e may receive the WUI 605-b, and may transmit WUN 610-b (e.g., between T2 and T3). In such examples, the UE 115-e may discharge, but at a rate slower than after T3 (e.g., when the UE 115-e is fully awake).

In some examples, if the time period 620 expires prior to a next on duration 615, one or more energy handshake messages may not be needed to support communications during the next on duration 615. In such examples, the UE 115-b may refrain from transmitting the WUN 610-b (e.g., based on having indicated the time period 620 in the WUN 610-a). Upon expiration of the time period 620, the UE 115-e may wake up (e.g., within receiving WUI 605-b, or without transmitting the WUN 610-b, or both) for on duration 615-c.

In some examples (e.g., after receiving the indication of the time period 620 and/or the power level of the UE 115-e in the WUN 610-a), the wireless device may implement a conservative approach to subsequent energy handshake messages. In such examples, the wireless device may perform two-stage energy handshake message signaling prior to a next on duration 615, requesting that the UE 115-a confirm whether it can wake up or not (e.g., may transmit a first-stage WUI 605), and may monitor for a first-stage WUN 610 responsive to the first-stage WUI 605-b).

In some examples, (e.g., after receiving the indication of the time period 620 and/or the power level of the UE 115-e in the WUN 610-a), the wireless device may implement a conservative approach to subsequent energy handshake messages. In such examples, the wireless device may assume that the UE 115-e is able to wake up for a next on duration 615-c (e.g., after time period 620), and may cancel first-stage WUI 605 and first-stage WUN 610). In such examples, the wireless device may transmit a second-stage WUI 605, and may monitor for a second-stage WUN 610. In some examples, the wireless device may cancel a first-stage WUI 605, but may still monitor for a first-stage WUN 610. If the wireless device receives a first-stage WUN 610 (e.g., including a one-bit indicator set to 0 indicating that the UE 115-e needs more time to fully charge), then the wireless device may determine that the UE 115-e is not able to communicate during a next on duration 615. The amount of time indicated by the UE 115-e may be preconfigured, or may be included in a second-stage WUN 610.

In some examples, the UE 115-e may receive, in a second-stage WUI 605, an indication of a duration of pending communications from the wireless device (e.g., the network may indicate, to the UE 115-e, how much data is pending for the UE 115-e, or how long communication of such pending data will last). Such indications may be applicable to downlink communications or pending sidelink communications. Based on such information, the UE 115-e may predict how much energy it will need to complete the data communication. The UE 115-e may indicate, in a responsive second-stage WUN 610, whether it is capable of performing the pending communication during a next or current on duration 615.

The UE 115-e, the wireless device, or both, may determine an amount of time to perform uplink data preparation and transmission, or downlink data reception, based on one or more parameters. The parameters may include a battery status at the UE 115-e, a pathloss of communications between the UE 115-e and the wireless device, a target power, an amount of a buffer status report (BSR), or any combination thereof. In some examples, the amount of time for uplink or downlink signaling may be derived based on a target uplink power level at the wireless device (e.g., a network entity 105), and a transmit power of the WUI 605. Such information may be configured via higher layer signaling (e.g., RRC signaling). The UE 115-e may compute a pathloss based on a receive power of the WUI 605, and may predict how much energy will be used if there is uplink data to transmit. If battery power is not enough for such a transmission, then the UE 115-e may not send a scheduling request, or a BSR to request uplink grants of resources. Similarly, the WUN 610 (e.g., a second-stage WUN 610) may indicate a duration that the UE 115-e can sustain data transmission and reception with the network. Such information may be calculated for both downlink and uplink communication, and based thereon, the network may determine whether important or high priority information is to be sent first to the UE 115-e (e.g., during the amount of time for which the UE 115-e can remain active). In some examples, if the UE 115-e goes to sleep or enters an inactivity state, the UE 115-e may reset one or more DRX related timers, such as an inactivity timer, and a HARQ round trip time (RTT) (e.g., downlink and uplink) timer. In some examples, the UE 115-e may indicate a charging rate and/or a discharging rate to the wireless device. The UE 115-e may indicate a threshold amount of uplink or downlink BSR. In some cases, the UE 115-e may indicate the charging rate, discharging rate, or threshold BSR, or any combination thereof, periodically. In some examples, the UE may reset one or more HARQ RTT timers if the UE enters an out of power mode or runs out of energy (e.g., an energy level is reduced beyond a threshold level) or if the UE sends an indication that it needs more time to sleep. In such examples, when UE wakes up (e.g., when the UE has an energy level that satisfies a threshold), the UE may continue the HARQ RTT timer on a next DRX active time (e.g., a next on duration).

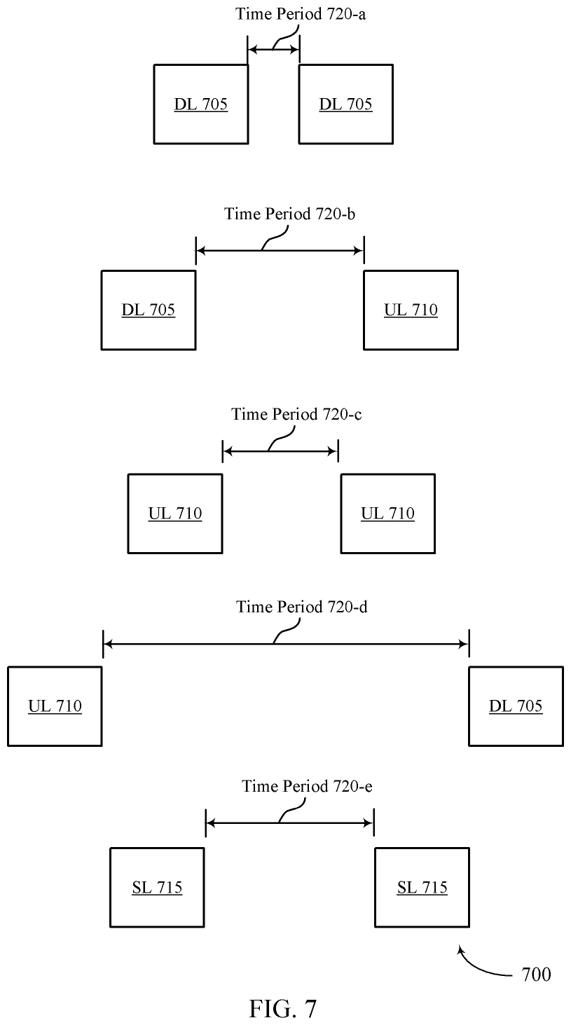

FIG. 7 illustrates an example of an energy handshake scheme 700 that supports multi-stage wakeup signaling for passive devices in accordance with one or more aspects of the present disclosure. In some examples, the energy handshake scheme 700 may implement, or be implemented by, aspects of wireless communications system 100, energy handshake scheme 200, energy handshake scheme 300, energy handshake scheme 400, energy handshake scheme 500, and energy handshake scheme 600. For example, a UE (e.g., a UE 115) may communicate with another UE 115, or a network entity 105, which may be examples of corresponding devices described with reference to FIG. 1. The UE and a wireless device (e.g., a network entity 105, or a sidelink UE 115) may perform techniques described herein.

The UE may indicate, to the wireless device, a threshold amount of time (e.g., a minimum time gap) between uplink or downlink resources (e.g., physical downlink shared channel (PDSCH) occasions or physical uplink shared channel (PUSCH) occasions) in which the UE is able to accumulate sufficient power to perform wireless communications on the uplink or downlink resources. The UE may be able to communicate during a second of two uplink or downlink occasions if a time period 720 is satisfied (e.g., if at least the time period 720 occurs between the two sets of resources of the uplink or downlink occasions). The threshold amount of time may be different for different types of communications.

The UE may indicate the one or more threshold time periods 720 in a second-stage WUN, or in one or more dedicated resources (e.g., or when configuring or negotiation allocated resources for uplink, downlink, or sidelink communications). For example, the UE may report time period 720-a between downlink occasions 705, may report time period 720-b between a downlink occasion 705 and an uplink occasion 710, may report time period 720-c between uplink occasions 710, may report time period 720-d between an uplink occasion 710 and a downlink occasion 705, and may report time period 720-e between SL occasions 715. Each reported time period 720 may indicate an amount of time the UE needs to recharge between the various sets of resources in order to be able to communicate using the resources.

The network may utilize such reported information (e.g., the threshold time periods 720) to configure resources for uplink communications, downlink communications, sidelink communications, or any combination thereof. For example, a network entity 105 may configure configured grants (CGs) and semipersistent scheduling (SPS) periodicities, a time between a PDSCH and HARQ-ACK resources, a time between PUSCH and a next (e.g., uplink or downlink) dynamic grant DG, a time between an SPS and a DG or an uplink CG, or any combination thereof.

In some examples, the time periods 720 may be a function of a type of channel or type of transmission. For example, the time periods 720 may be different for various sets or types of resources based on whether the corresponding resources are for SRS signaling, CSI-RS signaling, PDCCH signaling, PDSCH signaling, PUSCH signaling, PUCCH signaling, PSSCH signaling, RRC signaling, MAC-CE messages, user assistance information (UAI), or any combination thereof. Thus, in some examples, the UE may report different time periods 720 depending on whether a first message, transmission, reception, or channel, and a second message, transmission, reception, or channel, are respectively allocated for SRS, CSI-RS, PDCCH, PDSCH, PUSCH, PUCCH, PSSCH, RRC, MAC-CE, or UAI (e.g., among other examples). In some examples, the UE may report a time period 720 for each pair of resource types, each channel type, each transmission type, or a combination thereof. In some examples, the UE may determine a largest time period 720, and report that time period 720 (e.g., ensuring that no time gap between any type of channel or transmission will be too short for any communication).

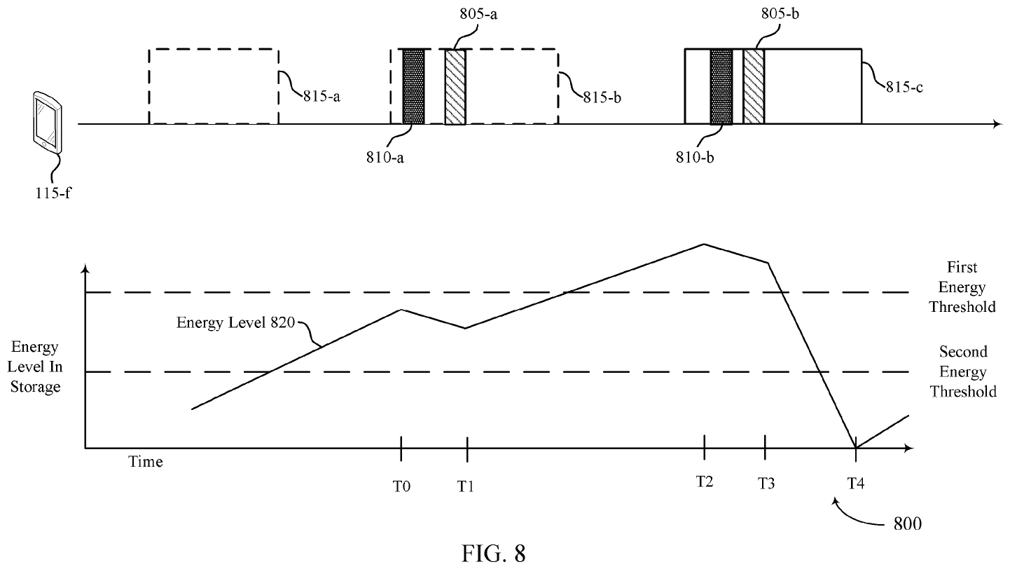

FIG. 8 illustrates an example of an energy handshake scheme 800 that supports multi-stage wakeup signaling for passive devices in accordance with one or more aspects of the present disclosure. In some examples, the energy handshake scheme 500 may implement, or be implemented by, aspects of wireless communications system 100, energy handshake scheme 200, energy handshake scheme 300, energy handshake scheme 400, energy handshake scheme 500, energy handshake scheme 600, and energy handshake scheme 700. For example, the UE 115-f may communicate with another UE 115, or a network entity 105, which may be examples of corresponding devices described with reference to FIG. 1. The UE 115-f and a wireless device (e.g., a network entity 105, or a sidelink UE 115) may perform techniques described herein.

In some examples, the UE 115-f may indicate to the wireless device that it is ready for wireless communications (e.g., prior to receiving an energy handshake message from the wireless device). For example, the UE 115-f may transmit one or more WUNs 610 prior to receiving one or more WUIs 605. In such examples, the UE 115-f may conserve power by not having to decode WUIs 605 when the UE 115-f is not ready for or does not have power for receiving the WUIs 605. This may also result in more efficient use of available resources for the network, or more saving of transmit power. For example, the UE 115-f may not have an energy level 820 high enough energy to communicate during on duration 815-a of a duty cycle. The UE 115-f may charge (e.g., increase energy level 820) via energy harvesting prior to time T0. At T0, the UE 115-f may have an energy level 820 that satisfies the second energy threshold, but not the first energy threshold (e.g., the UE 115-f operates in a partially charged state). The UE 115-f may transmit a WUN 610-a (e.g., indicating that it cannot communicate during the on duration 815-b), and/or may receive a responsive WUI 805-a. The UE 115-f may discharge slightly between T0 and T1, while transmitting and/or receiving energy handshake messages, but then may refrain from communicating data during on duration 815-b, and may instead continue to increase the energy level 820 by performing energy harvesting. The UE 115-f may have an energy level 820 that satisfies the first energy level by on duration 815-c. In such examples (e.g., without waiting to receive a WUI 805-a or a WUI 805-b), the UE 115-f may transmit a WUN 810-b, indicating that the UE 115-f can wake up and communicate during on duration 815-c. The UE 115-f may then perform uplink communications, downlink communications, sidelink communications, or a combination thereof during on duration 815-c.

Upon receiving the WUN 810-b, if the wireless device is ready to send downlink communication (e.g., if the wireless device is a network entity 105) or sidelink communication (e.g., if the wireless device is a UE 115), then the UE 115-f may monitor for and receive the communication during the on duration 815-c. Upon receiving the WUN 810-b, if the wireless device has no data to send to the UE 115-f (e.g., of if the UE 115-f has not requested resources on which to transmit data), then the network entity 105 may send energy to the UE (e.g., beamformed dedicated energy transfer signals) during the on duration 815-c to recharge some or all of the energy the UE 115-f spent in energy handshake messages between T2 and T3. In such examples, the UE 115-f may increase the energy level 820 during the remainder of the on duration 815-c.

The UE 115-f may transmit a WUN 810 prior to a WUI 805 in one or multiple stages of a multi-stage energy handshake protocol. For example, the UE 115-f may transmit (e.g., prior to an on duration 815) a first-stage WUN 810, and may receive a first-stage WUI 805. Then (e.g., during the next on duration 815 as illustrated with reference to FIG. 8, or prior to a next on duration 815) the UE 115-f may transmit a second-stage WUN 810, and may receive a response second-stage WUI 805.

In some cases, the UE 115-f may transmit the WUN 810 before receiving a WUI because, although the UE 115-f has no data to transmit, it may still transmit a WUN 810 to the network to indicate that its battery is low (e.g., its energy level 820 is low). In some examples, the network may schedule uplink or downlink communications accordingly (e.g., to allow the UE 115-f some time to perform energy harvesting), or may provide one or mor energy transfer signals to the UE 115-f to assist in energy harvesting.

In some examples, the UE 115-f may indicate to the wireless device information regarding a next (e.g., future) duty cycle (e.g., a next cycle or a next on duration of a DRX cycle). That is, the UE 115-f may transmit a WUN 810 during an on duration 815-b (e.g., using remaining power after any wireless communications during the on duration 815-b) for a next or future on duration 815-c. For example, before the UE 115-f enters a connected mode discontinuous reception cycle (CDRX) (e.g., before an inactivity expires), the UE 115-f may experience an energy level 820 that is low, but still supports further data communication with the wireless device. The UE 115-f may indicate, using the remaining power, the UE 115-f may transmit a WUN 810 including information for a subsequent on duration 815. For example, the UE 115-f may transmit the WUN 810-a (e.g., or a WUN 610, as described with reference to FIG. 6) including information regarding the UE 115-f power level or timing, or availability, for on duration 815-c. The UE 115-f may then recharge between T1 and T2, and may be ready to receive a corresponding WUI 805 (e.g., responsive to the WUN 810-a) or to perform wireless communications during on duration 815-b. Such deployments may support radio frequency harvesting for the UE 115-f, which may request energy from the network (e.g., at the end of one on duration 815, the UE 115-f may transmit a WUN 810 requesting an energy transfer signal from the network prior to a next or future on duration 815).

In some examples, the UE 115-f may transmit information (e.g., a WUN 810) in a standalone manner 9 e.g., based on random access signaling, or multiplexed with a random access channel, BSR, scheduling request, among other examples). The UE 115-f may transmit a WUN 810 (e.g., or the information associated with a WUN 810 as described herein) in the form of, or piggybacked on (e.g., multiplexed with) a random access message, BSR, or SR. For instance, the UE 115-f may include the WUN 810 in a two-step random access format (e.g., a first portion of the message is a preamble or sequence based signal, followed by a PUSCH transmission carrying information indicated by the UE 115-f). Such a message may be a standalone message (e.g., including first-stage WUN 810 and second-stage WUN 810), and may include such information as a time needed until charging is complete for the UE 115-f. In some examples, the UE 115-f may include the WUN 810 in a service request or a scheduling request (e.g., a one-bit indication, indicating a need for an uplink grant and/or a mechanism to indicate a communication level is reached). In some examples, the UE 115-f may include the WUN 810 in a BSR. In such examples, the UE 115-f may indicate, in the BSR, how much information it is able to decode (e.g., how much current power and expected charge would allow the UE 115-f to decode data of a certain size). THE UE 115-f may also suggest a threshold (e.g., maximum) supported MCS size for downlink transmissions, because each MCS may have a different decoding cost. The UE 115-f may indicate a threshold transmission MCS, because each encoding process may depend on and have a cost based on MCS.

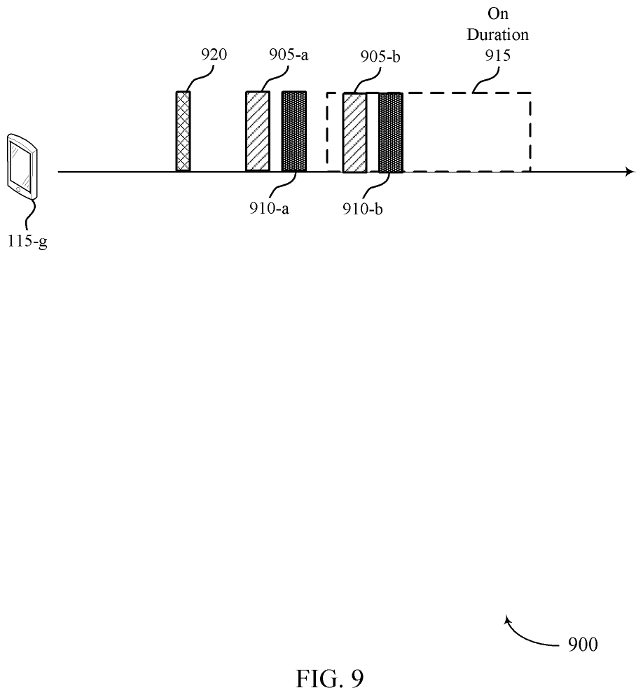

FIG. 9 illustrates an example of an energy handshake scheme 900 that supports multi-stage wakeup signaling for passive devices in accordance with one or more aspects of the present disclosure. In some examples, the energy handshake scheme 500 may implement, or be implemented by, aspects of wireless communications system 100, energy handshake scheme 200, energy handshake scheme 300, energy handshake scheme 400, energy handshake scheme 500, energy handshake scheme 600, energy handshake scheme 700, and energy handshake scheme 800. For example, the UE 115-g may communicate with another UE 115, or a network entity 105, which may be examples of corresponding devices described with reference to FIG. 1. The UE 115-g and a wireless device (e.g., a network entity 105, or a sidelink UE 115) may perform techniques described herein.

The UE 115-g may receive an early indication message 920 transmitted to a group of UEs 115 including the UE 115-g. The early indication message 920 may be a control message (e.g., on a PDCCH). For example, the early indication message 920 may be included in a DCI message, and may include device identifiers (e.g., UE identifiers) for each UE 115 in the group of UEs 115. UEs 115 in the group of UEs 115 that have enough energy made decode the early indication message 920, while UEs 115 that do not have enough energy may not decode the early indication message 920. In some examples, the early indication message 920 may be a sequence based DCI message transmitted on defined resources (e.g., a set of resources allocated to the group of UEs 115). In such examples, different sets of resources may be allocated to different groups, sets, or subsets, of UEs 115.

The UE 115-g may have enough energy to decode the early indication message 920, which may indicate that the UE 115-g (e.g., and any other UEs 115 in the group of UEs with sufficient energy) are to monitor for a first-stage WUI 905-a. The UE 115-g may successfully receive the first-stage WUI 905-a based on having received the early indication message 920. The first-stage WUI 905-a may be groupcast, and may be a one-bit signal (e.g., a sequence based signal) to wake up the group of UEs 115, including the UE 115-g. In some examples, the UE 115-g may transmit a first-stage WUN 910-a responsive to the first-stage WUI 905-a.

Based on the first-stage WUI 905-a, the UE 115-a may receive a second-stage WUI 905-a. While the first-stage WUI 905-a may be groupcast, the second-stage WUI 905-b may be unicast to the UE 115-g. For example, the wireless device, such as a network entity 105, may transmit a single groupcast first-stage WUI 905-a to a group of UEs 115, but may then transmit multiple individual unicast second-stage WUIs 905-b to the individual UEs 115 of the group of UEs 115 (e.g., to any of the group of UEs 115 that respond with a first-stage WUN 910-a). The UE 115-g may transmit a responsive second-stage WUN 910-b to the wireless device, and may (e.g., based on an energy level at the UE 115-g, as indicated in the second-stage WUN 910-b) transmit or receive data during on duration 915.

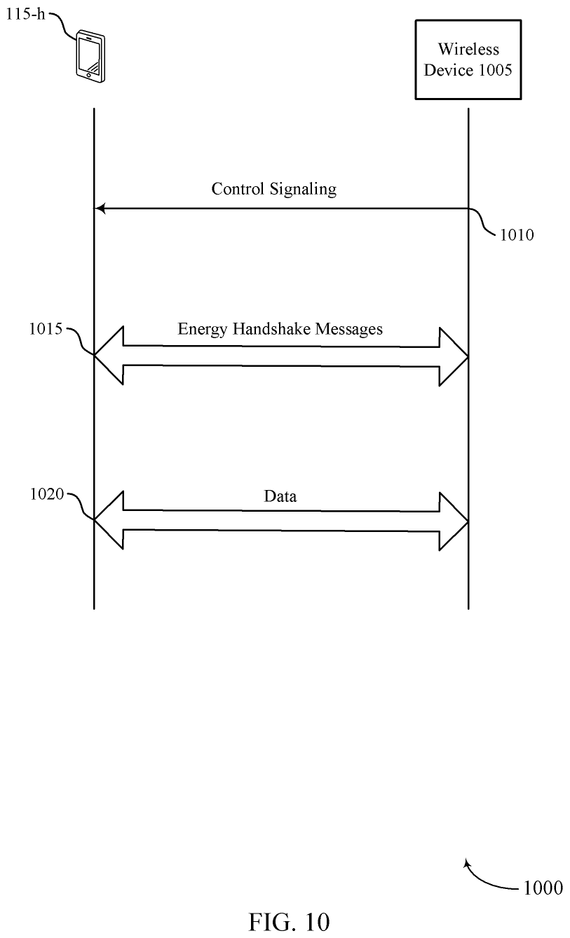

FIG. 10 illustrates an example of a process flow 1000 that supports multi-stage wakeup signaling for passive devices in accordance with one or more aspects of the present disclosure. Process flow 1000 may implement aspects of, or be implemented by aspects of, wireless communications system 100. For example, the process flow 1000 may include a UE 115-h and a wireless device 1005. The wireless device 1005 may be an example of a network entity 105, a sidelink UE 115. The UE 115-h and the wireless device 1005 may be examples of corresponding devices described with reference to FIGS. 1-9.

At 1010, the UE 115-h may receive control signaling from the wireless device 1005 (e.g., or any network entity 105). The control signaling may indicate resource allocated to one or more energy handshake messages of a multi-stage energy handshake protocol between the UE 115-h and the wireless device 1005. The one or more energy handshake messages may be associated with a repetition factor and a periodicity, as described in greater detail with reference to FIG. 2. In some examples, the UE 115-h may receive one or more SSBs corresponding to the allocated resources, and may determine the allocated resources for the energy handshake messages based on a mapping between the SSBs and the resources. In some examples, the control signaling may indicate a timing offset between first-stage energy handshake messages and second-stage energy handshake messages.

At 1015, the UE 115-h and the wireless device 1005 may exchange (e.g., transmit or receive) one or more energy handshake messages using the indicated resources and in accordance with the repetition factor and the periodicity.

In some examples (e.g., as described with reference to FIGS. 3-4), the one or more energy handshake messages may include a first-stage WUI and a first-stage WUN. The UE 115-h may receive the first-stage WUI including a sequence-based request that the UE transmit the first-stage WUN if a threshold energy level at the UE is satisfied (e.g., if the UE 115-h has an energy level high enough to communicate the data during the on duration, or if the UE 115-h has an energy level high enough to respond with the WUN). The UE 115-h may transmit the first-stage WUN including a sequence-based response to the first-stage WUI indicating that the UE is capable of waking up to performing additional communications (e.g., in a next on period of the DRX cycle). In some examples, the UE 115-h may receive a second-stage WU indication including an amount of data buffered for the UE 115-h from the wireless device 1005, and may transmit a second-stage WUN including an indication of a number of cycles of the DRX cycle after which the UE is capable of transmitting data at 1020.

In some examples, the UE 115-h may wake up upon expiration of the number of cycles, and may receive a second first-stage WUI (e.g., prior to a subsequent on period). The UE 115-h may revive a second first-stage WUI, and transmit a second first-stage WUN. The UE 115-h may receive a second first-stage WUI, and may transmit a second second-stage WUN. In some examples, instead of communicating additional first-stage WUIs and WUNs, the UE 115-h may wake up after expiration of the number of cycles, and may refrain from transmitting the second first-stage WUN. The UE 115-h may instead monitor for and receive a second second-stage WUI and transmit a second second-stage WUN.

The UE 115-h may indicate, in the second-stage WUN, an amount of time after which it will be able to communicate data at 1020. In some examples, the UE 115-d may determine the amount of time (e.g., the number of cycles) based at least in part on a default time value, a battery status, a pathloss, a target power, a buffer status report, an indication of a length of time for receiving the data buffered for the UE included in the second-stage wakeup indication, or any combination thereof. In some examples, the wireless device 1005 may configure the UE 115-h with the amount of time, or the amount of time may be included in one or more standards.

In some examples, the UE 115-h may monitor a set of one or more energy transfer resources for an energy transfer signal (e.g., as described with reference to FIG. 5). The network may configure, or the UE 115-h may negotiate, the resources. The UE 115-d may perform energy harvesting using the energy transfer signal.

In some examples, the UE 115-h may include, in a second-stage WUN, an indication of a threshold time gap between a first message and a second message (e.g., between uplink transmissions, between downlink transmissions, between and uplink transmission and a downlink transmission, between a downlink transmission and an uplink transmission, or between sidelink transmissions), as described in greater detail with reference to FIG. 7. The threshold time gap may be based at least in part on a type of channel or type of transmission associated with the first message, a type of channel associated with the second message, or both.

In some examples, the UE 115-h may receive a DCI message including an instruction for a set of UEs 115 including the UE 115-h to monitor for the fir-stage WUI (e.g., as described in greater detail with reference to FIG. 9. Receiving the first-stage WUI may be based on receiving the DCI message. The UE 115-h may decode a UE identifier for the UE 115-h, and may receive the instruction based on having decoded the UE 115-g. In some examples, the UE 115-h may receive control signaling indicating a set of resources for the set of UEs to monitor, and may receive the DCI message based on monitoring the indicated set of resources. The first-stage WUI may be groupcast or multicast, and the second-stage WUI may be multicast.

In some examples, the UE 115-h may refrain from transmitting a first-stage WUN based on the UE 115-h not having enough energy to transmit the WUN or communicate data. The UE 115-h may go to sleep or enter an idle mode (e.g., may begin recharging), and may subsequently receive another WUI after a period of time, based on having refrained from transmitting the WUN. The UE 115-h may receive control signaling indicating the threshold period of time, or may determine the threshold period of time based at least in part on how much time it will take to achieve a power charging threshold sufficient for performing wireless communications during the one or more on periods of the discontinuous reception cycle.

In some examples, as described in greater detail with reference to FIG. 8, the UE 115-h may transmit a WUN (e.g., a first-stage WUN, a second-stage WUN, or both) prior to receiving a WUI (e.g., a first-stage WUI, a second-stage WUI, or both). The UE 115-h may transmit, prior to expiration of an inactivity timer, an indication of the UE capability in a next on period (e.g., a WUN associated with a next on period).

The UE 115-h may include the WUN, or information associated with a WUN as described herein, in a random access message, a service request, a scheduling request, a BSR, or a combination thereof. The UE 115-a may include, in a first-stage WUN or a second-stage WUN, an indication of a battery power level of the UE 115-h.

At 1020, the UE 115-h and the wireless device 1005 may exchange (e.g., transmit or receive) data during one or more on periods (e.g., on durations) of a duty cycle (e.g., a DRX cycle) based at least in part on the one or more energy handshake message.

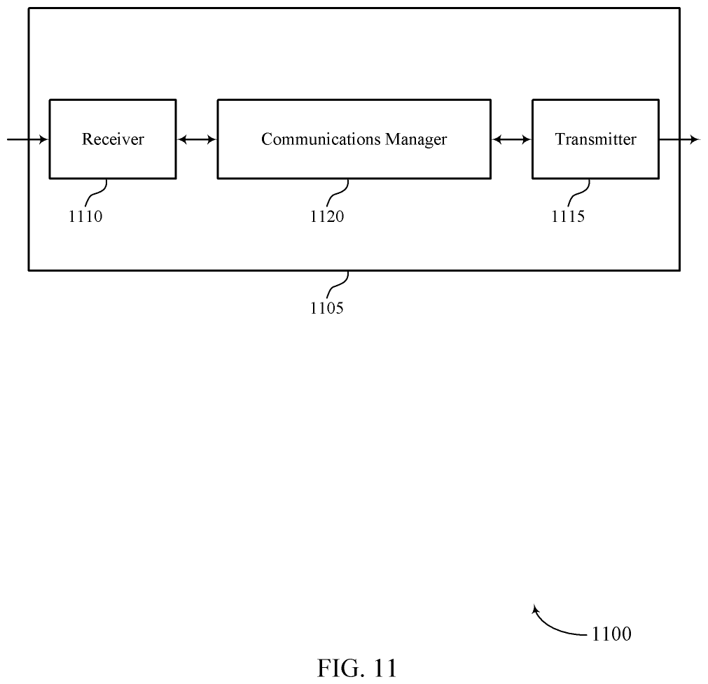

FIG. 11 shows a block diagram 1100 of a device 1105 that supports multi-stage wakeup signaling for passive devices in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to multi-stage wakeup signaling for passive devices). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to multi-stage wakeup signaling for passive devices). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of multi-stage wakeup signaling for passive devices as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), a graphic processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. For example, the communications manager 1120 may be configured as or otherwise support a means for receiving control signaling indicating resources allocated to one or more energy handshake messages of a multi-stage energy handshake protocol between the UE and a wireless device, where the one or more energy handshake messages is associated with a repetition factor and a periodicity. The communications manager 1120 may be configured as or otherwise support a means for transmitting or receiving the one or more energy handshake messages using the indicated resources and in accordance with the repetition factor and the periodicity. The communications manager 1120 may be configured as or otherwise support a means for transmitting or receiving data during one or more on periods of a discontinuous reception cycle based on the one or more energy handshake messages.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for energy handshake protocols resulting in reduced power consumption, improved battery life, more efficient use of available system resources, and improved user experience.

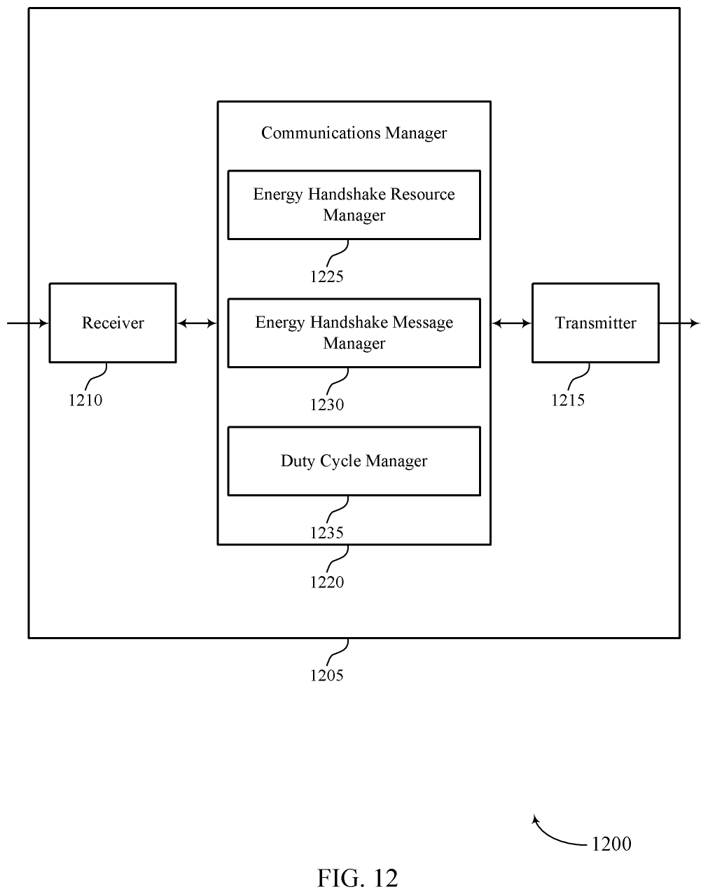

FIG. 12 shows a block diagram 1200 of a device 1205 that supports multi-stage wakeup signaling for passive devices in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to multi-stage wakeup signaling for passive devices). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to multi-stage wakeup signaling for passive devices). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of multi-stage wakeup signaling for passive devices as described herein. For example, the communications manager 1220 may include an energy handshake resource manager 1225, an energy handshake message manager 1230, a duty cycle manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. The energy handshake resource manager 1225 may be configured as or otherwise support a means for receiving control signaling indicating resources allocated to one or more energy handshake messages of a multi-stage energy handshake protocol between the UE and a wireless device, where the one or more energy handshake messages is associated with a repetition factor and a periodicity. The energy handshake message manager 1230 may be configured as or otherwise support a means for transmitting or receiving the one or more energy handshake messages using the indicated resources and in accordance with the repetition factor and the periodicity. The duty cycle manager 1235 may be configured as or otherwise support a means for transmitting or receiving data during one or more on periods of a discontinuous reception cycle based on the one or more energy handshake messages.

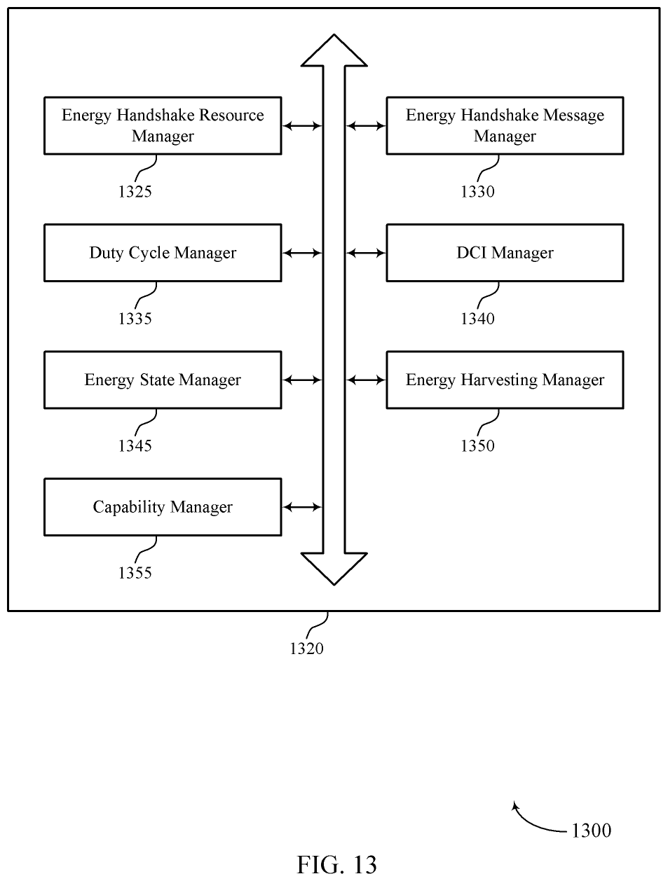

FIG. 13 shows a block diagram 1300 of a communications manager 1320 that supports multi-stage wakeup signaling for passive devices in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of multi-stage wakeup signaling for passive devices as described herein. For example, the communications manager 1320 may include an energy handshake resource manager 1325, an energy handshake message manager 1330, a duty cycle manager 1335, a DCI manager 1340, an energy state manager 1345, an energy harvesting manager 1350, a capability manager 1355, or any combination thereof. Each of these components may communicate, directly or indirectly, with one another (e.g., via one or more buses).

The communications manager 1320 may support wireless communications at a UE in accordance with examples as disclosed herein. The energy handshake resource manager 1325 may be configured as or otherwise support a means for receiving control signaling indicating resources allocated to one or more energy handshake messages of a multi-stage energy handshake protocol between the UE and a wireless device, where the one or more energy handshake messages is associated with a repetition factor and a periodicity. The energy handshake message manager 1330 may be configured as or otherwise support a means for transmitting or receiving the one or more energy handshake messages using the indicated resources and in accordance with the repetition factor and the periodicity. The duty cycle manager 1335 may be configured as or otherwise support a means for transmitting or receiving data during one or more on periods of a discontinuous reception cycle based on the one or more energy handshake messages.

In some examples, to support transmitting or receiving the one or more energy handshake messages, the energy handshake message manager 1330 may be configured as or otherwise support a means for receiving the first-stage wakeup indication including a sequence-based request that the UE transmit the first-stage wakeup notification if a threshold energy level at the UE is satisfied. In some examples, to support transmitting or receiving the one or more energy handshake messages, the energy handshake message manager 1330 may be configured as or otherwise support a means for transmitting, based on receiving the first-stage wakeup indication and the threshold energy level at the UE being satisfied, the first-stage wakeup notification including a sequence-based response to the first-stage wakeup indication indicating that the UE is capable of waking up to perform additional communications.

In some examples, to support transmitting or receiving the one or more energy handshake messages, the energy handshake message manager 1330 may be configured as or otherwise support a means for receiving, based on transmitting the first-stage wakeup notification, the second-stage wakeup indication including an amount of data buffered for the UE. In some examples, to support transmitting or receiving the one or more energy handshake messages, the energy handshake message manager 1330 may be configured as or otherwise support a means for transmitting, based on receiving the second-stage wakeup indication, the second-stage wakeup notification including an indication of a number of cycles of the discontinuous reception cycle after which the UE is capable of transmitting data or receiving the data buffered for the UE.

In some examples, to support transmitting or receiving the one or more energy handshake messages, the duty cycle manager 1335 may be configured as or otherwise support a means for waking up after expiration of the number of cycles of the discontinuous reception cycle. In some examples, to support transmitting or receiving the one or more energy handshake messages, the energy handshake message manager 1330 may be configured as or otherwise support a means for receiving a second first-stage wakeup indication. In some examples, to support transmitting or receiving the one or more energy handshake messages, the energy handshake message manager 1330 may be configured as or otherwise support a means for transmitting, based on receiving the second first-stage wakeup indication, a second first-stage wakeup notification including a sequence-based response to the second first-stage wakeup indication indicating that the UE is capable of waking up to perform additional communications. In some examples, to support transmitting or receiving the one or more energy handshake messages, the energy handshake message manager 1330 may be configured as or otherwise support a means for receiving, based on transmitting the second first-stage wakeup notification, a second second-stage wakeup indication. In some examples, to support transmitting or receiving the one or more energy handshake messages, the energy handshake message manager 1330 may be configured as or otherwise support a means for transmitting, based on receiving the second second-stage wakeup indication, a second second-stage wakeup notification indicating that the UE is capable of receiving the data buffered for the UE or transmitting data in a next on period of the discontinuous reception cycle.

In some examples, to support transmitting or receiving the one or more energy handshake messages, the duty cycle manager 1335 may be configured as or otherwise support a means for waking up after expiration of the number of cycles of the discontinuous reception cycle. In some examples, to support transmitting or receiving the one or more energy handshake messages, the energy handshake message manager 1330 may be configured as or otherwise support a means for refraining from transmitting a second first-stage wakeup notification based on transmitting the second-stage wakeup notification. In some examples, to support transmitting or receiving the one or more energy handshake messages, the energy handshake message manager 1330 may be configured as or otherwise support a means for receiving, based on transmitting the second-stage wakeup indication including the indication of the number of cycles of the discontinuous reception cycle, a second second-stage wakeup indication. In some examples, to support transmitting or receiving the one or more energy handshake messages, the energy handshake message manager 1330 may be configured as or otherwise support a means for transmitting, based on receiving the second second-stage wakeup indication, a second second-stage wakeup notification indicating that the UE is capable of receiving the data buffered for the UE or transmitting data in a next on period of the discontinuous reception cycle.

In some examples, the energy handshake resource manager 1325 may be configured as or otherwise support a means for monitoring a set of one or more energy transfer resources for an energy transfer signal based on transmitting the second-stage wakeup notification. In some examples, the energy harvesting manager 1350 may be configured as or otherwise support a means for performing energy harvesting using the energy transfer signal, where transmitting the second-stage wakeup notification is based on performing the energy harvesting.

In some examples, the energy state manager 1345 may be configured as or otherwise support a means for determining the number of cycles of the discontinuous reception cycle after which the UE is capable of receiving the data buffered for the UE or transmitting data based on a default time value, a battery status, a pathloss, a target power, a buffer status report, an indication of a length of time for receiving the data buffered for the UE included in the second-stage wakeup indication, or any combination thereof.

In some examples, the energy handshake message manager 1330 may be configured as or otherwise support a means for including, in the second-stage wakeup notification, an indication of a threshold time gap between a first message including an uplink message, a downlink message, or a sidelink message, and a second message including a downlink message, an uplink message, or a sidelink message, where the threshold time gap is based at least in part on a type of channel associated with the first message, a type of channel associated with the second message, or both.

In some examples, the DCI manager 1340 may be configured as or otherwise support a means for receiving a downlink control information message including an instruction for a set of UEs including the UE to monitor for the first-stage wakeup indication, where receiving the first-stage wakeup indication is based on receiving the downlink control information message.

In some examples, the DCI manager 1340 may be configured as or otherwise support a means for decoding, in the downlink control information message, a UE identifier associated with the UE, where receiving the instruction for the set of UEs to monitor for the first-stage wakeup indication is based on decoding the UE identifier associated with the UE.

In some examples, the DCI manager 1340 may be configured as or otherwise support a means for receiving an indication of a set of resources on which the set of UEs is to monitor for the downlink control information message, where receiving the downlink control information message is based on monitoring the set of resources.

In some examples, the one or more energy handshake messages further include a second-stage wakeup notification. In some examples, the first-stage wakeup indication is multicast, and the second-stage wakeup indication is unicast.

In some examples, to support transmitting or receiving the one or more energy handshake messages, the energy handshake message manager 1330 may be configured as or otherwise support a means for receiving the first-stage wakeup indication including a sequence-based request that the UE transmit a first-stage wakeup notification if a threshold energy level at the UE is satisfied. In some examples, to support transmitting or receiving the one or more energy handshake messages, the energy handshake message manager 1330 may be configured as or otherwise support a means for refraining from transmitting the first-stage wakeup notification based on the threshold energy level at the UE not being satisfied. In some examples, to support transmitting or receiving the one or more energy handshake messages, the energy handshake message manager 1330 may be configured as or otherwise support a means for receiving the second first-stage wakeup indication after a threshold period of time based on refraining from transmitting the first-stage wakeup notification.

In some examples, the energy state manager 1345 may be configured as or otherwise support a means for receiving control signaling including an indication of the threshold period of time.

In some examples, the energy state manager 1345 may be configured as or otherwise support a means for determining the threshold period of time based on a power charging threshold sufficient for performing wireless communications during the one or more on periods of the discontinuous reception cycle.

In some examples, the energy handshake resource manager 1325 may be configured as or otherwise support a means for receiving a synchronization signal block corresponding to the resources allocated to the one or more energy handshake messages, where the control signaling indicating the resources includes a mapping between the synchronization signal block and the resources, and where transmitting or receiving the one or more energy handshake messages is based on a determination of the resources based on the mapping.

In some examples, the energy handshake resource manager 1325 may be configured as or otherwise support a means for receiving, in the control signaling indicating the resources allocated to the one or more energy handshake messages, an indication of a timing offset between the first-stage wakeup indication and the first-stage wakeup notification, and the second-stage wakeup indication and the second-stage wakeup notification.

In some examples, to support transmitting or receiving the one or more energy handshake messages, the energy handshake message manager 1330 may be configured as or otherwise support a means for transmitting, based on a threshold energy level at the UE being satisfied, the first-stage wakeup notification including a sequence-based indication that the UE is capable of waking up to perform additional communications. In some examples, to support transmitting or receiving the one or more energy handshake messages, the energy handshake message manager 1330 may be configured as or otherwise support a means for receiving, based on transmitting the first-stage wakeup notification, the first-stage wakeup indication responsive to the first-stage wakeup notification.

In some examples, transmitting or receiving data during the one or more on periods of the discontinuous reception cycle is based on receiving the first-stage wakeup indication.

In some examples, the capability manager 1355 may be configured as or otherwise support a means for transmitting, prior to expiration of an inactivity timer during the one or more on periods of the discontinuous reception cycle, an indication of UE capability in a next on period of the discontinuous reception cycle.

In some examples, the energy harvesting manager 1350 may be configured as or otherwise support a means for receiving an energy transfer signal during the one or more on periods of the discontinuous reception cycle and based on receiving the first-stage wakeup notification.

In some examples, the energy handshake message manager 1330 may be configured as or otherwise support a means for including, in the first-stage wakeup notification, an indication of a battery power level of the UE.

In some examples, to support transmitting the first-stage wakeup notification, the energy handshake message manager 1330 may be configured as or otherwise support a means for including the first-stage wakeup notification in a random access message, a service request, a scheduling request, a buffer status report, or a combination thereof.

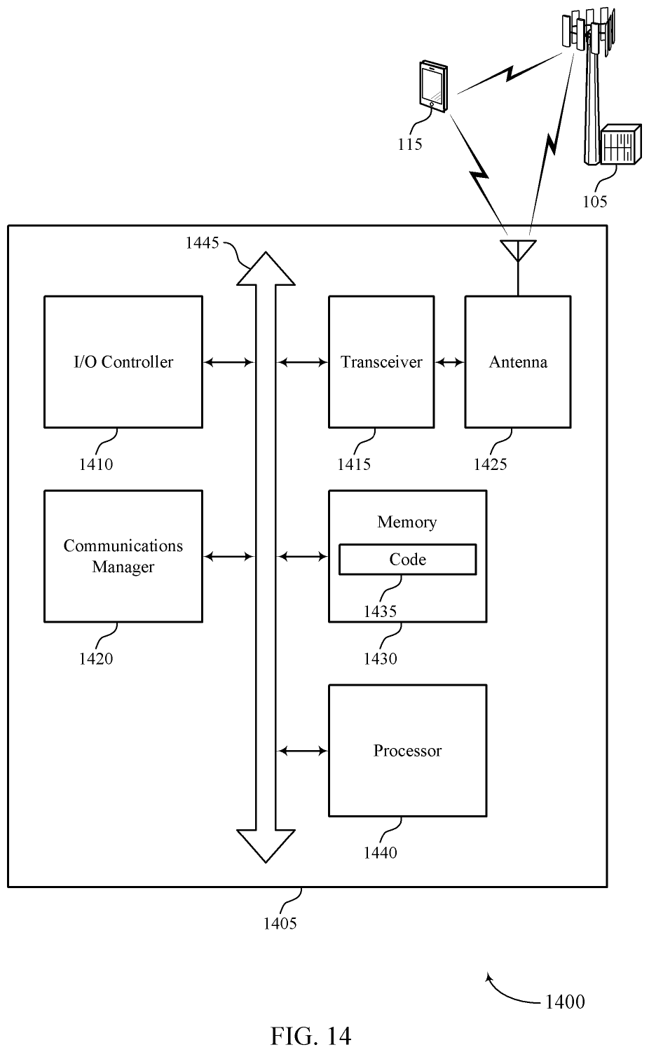

FIG. 14 shows a diagram of a system 1400 including a device 1405 that supports multi-stage wakeup signaling for passive devices in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOSR, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting multi-stage wakeup signaling for passive devices). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a UE in accordance with examples as disclosed herein. For example, the communications manager 1420 may be configured as or otherwise support a means for receiving control signaling indicating resources allocated to one or more energy handshake messages of a multi-stage energy handshake protocol between the UE and a wireless device, where the one or more energy handshake messages is associated with a repetition factor and a periodicity. The communications manager 1420 may be configured as or otherwise support a means for transmitting or receiving the one or more energy handshake messages using the indicated resources and in accordance with the repetition factor and the periodicity. The communications manager 1420 may be configured as or otherwise support a means for transmitting or receiving data during one or more on periods of a discontinuous reception cycle based on the one or more energy handshake messages.

By including or configuring the communications manager 1420 in accordance with examples as described herein, the device 1405 may support techniques for energy handshake protocols resulting in reduced power consumption, improved battery life, improved communication reliability, reduced latency, improved user experience related to reduced processing, reduced power consumption, more efficient utilization of communication resources, and improved user experience.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of multi-stage wakeup signaling for passive devices as described herein, or the processor 1440 and the memory 1430 may be otherwise configured to perform or support such operations.

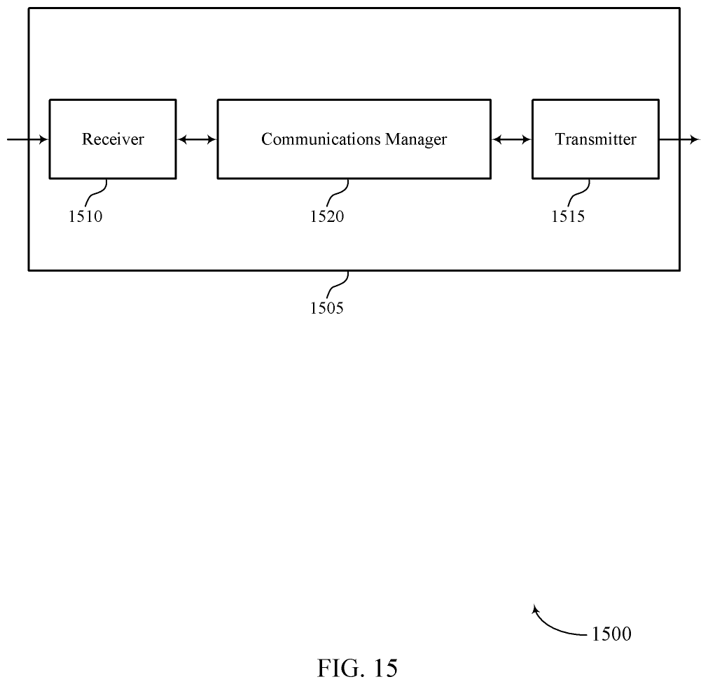

FIG. 15 shows a block diagram 1500 of a device 1505 that supports multi-stage wakeup signaling for passive devices in accordance with one or more aspects of the present disclosure. The device 1505 may be an example of aspects of a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas.

Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations thereof or various components thereof may be examples of means for performing various aspects of multi-stage wakeup signaling for passive devices as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, a CPU, GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software) executed by a processor. If implemented in code executed by a processor, the functions of the communications manager 1520, the receiver 1510, the transmitter 1515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a wireless device in accordance with examples as disclosed herein. For example, the communications manager 1520 may be configured as or otherwise support a means for outputting control signaling indicating resources allocated to one or more energy handshake messages of a multi-stage energy handshake protocol between the wireless device and a UE, where the one or more energy handshake messages is associated with a repetition factor and a periodicity. The communications manager 1520 may be configured as or otherwise support a means for outputting or obtaining the one or more energy handshake messages using the indicated resources and in accordance with the repetition factor and the periodicity. The communications manager 1520 may be configured as or otherwise support a means for outputting or obtaining data during one or more on periods of a discontinuous reception cycle based on the one or more energy handshake messages.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for energy handshake protocols resulting in reduced power consumption, improved battery life, more efficient use of available system resources, and improved user experience.

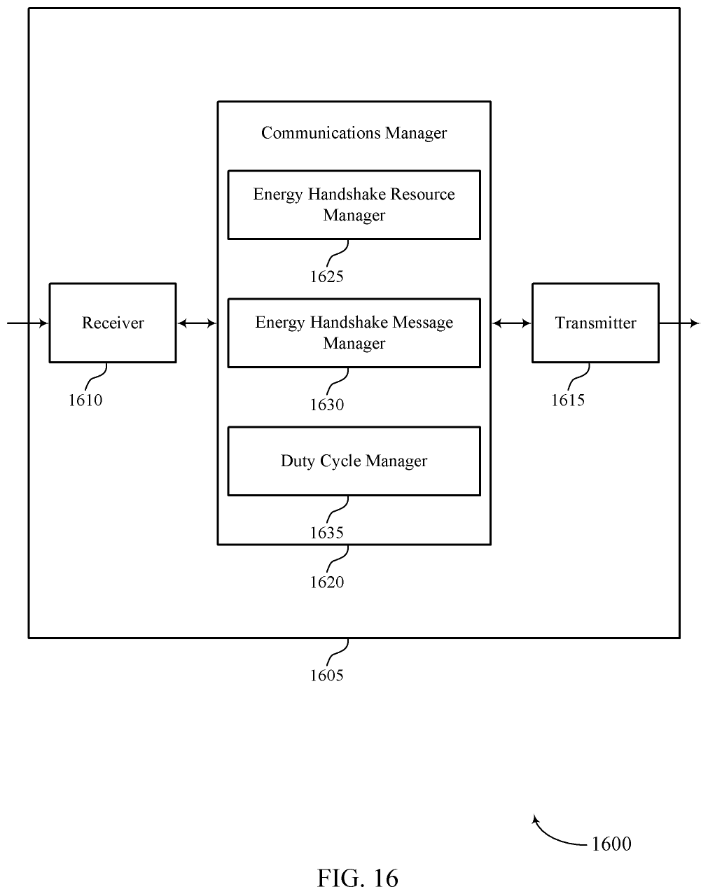

FIG. 16 shows a block diagram 1600 of a device 1605 that supports multi-stage wakeup signaling for passive devices in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of multi-stage wakeup signaling for passive devices as described herein. For example, the communications manager 1620 may include an energy handshake resource manager 1625, an energy handshake message manager 1630, a duty cycle manager 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a wireless device in accordance with examples as disclosed herein. The energy handshake resource manager 1625 may be configured as or otherwise support a means for outputting control signaling indicating resources allocated to one or more energy handshake messages of a multi-stage energy handshake protocol between the wireless device and a UE, where the one or more energy handshake messages is associated with a repetition factor and a periodicity. The energy handshake message manager 1630 may be configured as or otherwise support a means for outputting or obtaining the one or more energy handshake messages using the indicated resources and in accordance with the repetition factor and the periodicity. The duty cycle manager 1635 may be configured as or otherwise support a means for outputting or obtaining data during one or more on periods of a discontinuous reception cycle based on the one or more energy handshake messages.

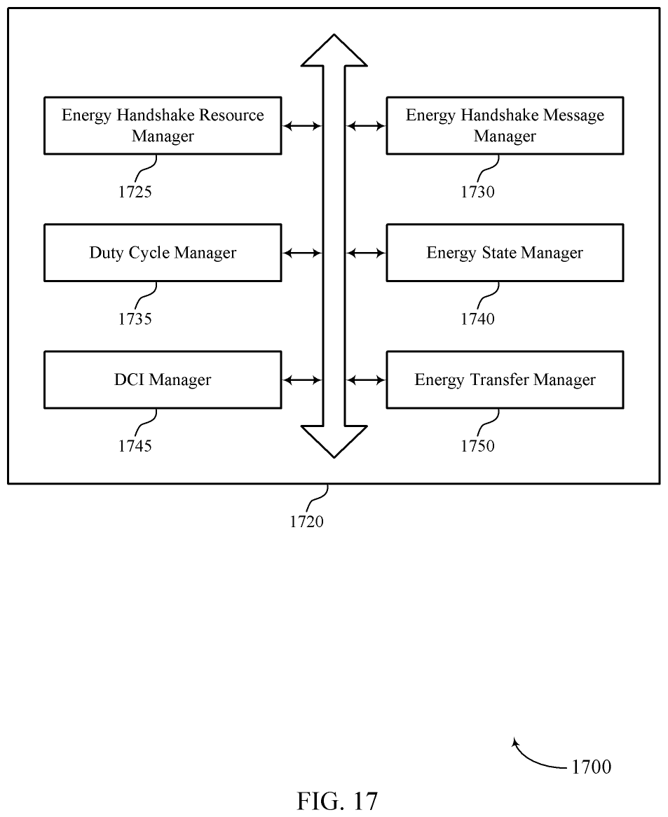

FIG. 17 shows a block diagram 1700 of a communications manager 1720 that supports multi-stage wakeup signaling for passive devices in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of multi-stage wakeup signaling for passive devices as described herein. For example, the communications manager 1720 may include an energy handshake resource manager 1725, an energy handshake message manager 1730, a duty cycle manager 1735, an energy state manager 1740, a DCI manager 1745, an energy transfer manager 1750, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications at a wireless device in accordance with examples as disclosed herein. The energy handshake resource manager 1725 may be configured as or otherwise support a means for outputting control signaling indicating resources allocated to one or more energy handshake messages of a multi-stage energy handshake protocol between the wireless device and a UE, where the one or more energy handshake messages is associated with a repetition factor and a periodicity. The energy handshake message manager 1730 may be configured as or otherwise support a means for outputting or obtaining the one or more energy handshake messages using the indicated resources and in accordance with the repetition factor and the periodicity. The duty cycle manager 1735 may be configured as or otherwise support a means for outputting or obtaining data during one or more on periods of a discontinuous reception cycle based on the one or more energy handshake messages.

In some examples, to support outputting or obtaining the one or more energy handshake messages, the energy handshake message manager 1730 may be configured as or otherwise support a means for outputting the first-stage wakeup indication including a sequence-based request that the UE transmit the first-stage wakeup notification if a threshold energy level at the UE is satisfied. In some examples, to support outputting or obtaining the one or more energy handshake messages, the energy handshake message manager 1730 may be configured as or otherwise support a means for obtaining, based on outputting the first-stage wakeup indication and the threshold energy level at the UE being satisfied, the first-stage wakeup notification including a sequence-based response to the first-stage wakeup indication indicating that the UE is capable of waking up to perform additional communications.

In some examples, to support outputting or obtaining the one or more energy handshake messages, the energy handshake message manager 1730 may be configured as or otherwise support a means for outputting, based on obtaining the first-stage wakeup notification, the second-stage wakeup indication including an amount of data buffered for the UE. In some examples, to support outputting or obtaining the one or more energy handshake messages, the energy handshake message manager 1730 may be configured as or otherwise support a means for obtaining, based on outputting the second-stage wakeup indication, the second-stage wakeup notification including an indication of a number of cycles of the discontinuous reception cycle after which the UE is capable of transmitting data or receiving the data buffered for the UE.

In some examples, to support outputting or obtaining the one or more energy handshake messages, the energy handshake message manager 1730 may be configured as or otherwise support a means for outputting the second first-stage wakeup indication upon expiration of the number cycles of the discontinuous reception cycle. In some examples, to support outputting or obtaining the one or more energy handshake messages, the energy handshake message manager 1730 may be configured as or otherwise support a means for obtaining, based on outputting the second first-stage wakeup indication, a second first-stage wakeup notification including a sequence-based response to the second first-stage wakeup indication indicating that the UE is capable of waking up to perform additional communications. In some examples, to support outputting or obtaining the one or more energy handshake messages, the energy handshake message manager 1730 may be configured as or otherwise support a means for outputting, based on obtaining the second first-stage wakeup notification, a second second-stage wakeup indication. In some examples, to support outputting or obtaining the one or more energy handshake messages, the energy handshake message manager 1730 may be configured as or otherwise support a means for obtaining, based on outputting the second second-stage wakeup indication, a second second-stage wakeup notification indicating that the UE is capable of receiving the data buffered for the UE or transmitting data in a next on period of the discontinuous reception cycle.

In some examples, to support outputting or obtaining the one or more energy handshake messages, the energy handshake message manager 1730 may be configured as or otherwise support a means for outputting, upon expiration of the number of cycles of the discontinuous reception cycle and based on obtaining the second-stage wakeup notification, a second second-stage wakeup indication. In some examples, to support outputting or obtaining the one or more energy handshake messages, the energy handshake message manager 1730 may be configured as or otherwise support a means for obtaining, based on outputting the second second-stage wakeup indication, a second second-stage wakeup notification indicating that the UE is capable of receiving the data buffered for the UE or transmitting data in a next on period of the discontinuous reception cycle.

In some examples, the energy transfer manager 1750 may be configured as or otherwise support a means for outputting, via a set of one or more energy transfer resources, an energy transfer signal based on obtaining the second-stage wakeup notification.

In some examples, the number of cycles of the discontinuous reception cycles is based on a default time value, a battery status, a pathloss, a target power, a buffer status report, an indication of a length of time for receiving the data buffered for the UE included in the second-stage wakeup indication, or any combination thereof.

In some examples, the duty cycle manager 1735 may be configured as or otherwise support a means for obtaining, in the second-stage wakeup notification, an indication of a threshold time gap between a first message including an uplink message, a downlink message, or a sidelink message, and a second message including a downlink message, an uplink message, or a sidelink message, where the threshold time gap is based at least in part on a type of channel associated with the first message, a type of channel associated with the second message, or both.

In some examples, the DCI manager 1745 may be configured as or otherwise support a means for outputting a downlink control information message including an instruction for a set of UEs including the UE to monitor for the first-stage wakeup indication, where outputting the first-stage wakeup indication is based on outputting the downlink control information message.

In some examples, the DCI manager 1745 may be configured as or otherwise support a means for including, in the downlink control information message, a set of UE identifiers for the set of UEs, the set of UE identifiers including a UE identifier associated with the UE.

In some examples, the energy handshake resource manager 1725 may be configured as or otherwise support a means for outputting an indication of a set of resources on which the set of UEs is to monitor for the downlink control information message.

In some examples, the one or more energy handshake messages further include a second second-stage wakeup notification. In some examples, the first-stage wakeup indication is multicast, and the second-stage wakeup indication is unicast.

In some examples, to support transmitting or receiving the one or more energy handshake messages, the energy handshake message manager 1730 may be configured as or otherwise support a means for outputting the first-stage wakeup indication including a sequence-based request that the UE transmit a first-stage wakeup notification if a threshold energy level at the UE is satisfied. In some examples, to support transmitting or receiving the one or more energy handshake messages, the energy handshake message manager 1730 may be configured as or otherwise support a means for monitoring for the first-stage wakeup notification based on outputting the first-stage wakeup indication. In some examples, to support transmitting or receiving the one or more energy handshake messages, the energy handshake message manager 1730 may be configured as or otherwise support a means for outputting a second first-stage wakeup indication after a threshold period of time based on the monitoring.

In some examples, the energy state manager 1740 may be configured as or otherwise support a means for outputting control signaling including an indication of the threshold period of time.

In some examples, the energy state manager 1740 may be configured as or otherwise support a means for determining the threshold period of time based on a power charging threshold sufficient for performing wireless communications during the one or more on periods of the discontinuous reception cycle.

In some examples, the energy handshake resource manager 1725 may be configured as or otherwise support a means for outputting a synchronization signal block corresponding to the resources allocated to the one or more energy handshake messages, where the control signaling indicating the resources includes a mapping between the synchronization signal block and the resources, and where outputting or obtaining the one or more energy handshake messages is based on a determination of the resources based on the mapping.

In some examples, the energy handshake resource manager 1725 may be configured as or otherwise support a means for outputting, in the control signaling indicating the resources allocated to the one or more energy handshake messages, an indication of a timing offset between the first-stage wakeup indication and the first-stage wakeup notification, and the second-stage wakeup indication and the second-stage wakeup notification.

In some examples, to support outputting or obtaining the one or more energy handshake messages, the energy state manager 1740 may be configured as or otherwise support a means for obtaining, based on a threshold energy level at the UE being satisfied, the first-stage wakeup notification including a sequence-based indication that the UE is capable of waking up to perform additional communications. In some examples, to support outputting or obtaining the one or more energy handshake messages, the energy state manager 1740 may be configured as or otherwise support a means for outputting, based on obtaining the first-stage wakeup notification, the first-stage wakeup indication responsive to the first-stage wakeup notification.

In some examples, the duty cycle manager 1735 may be configured as or otherwise support a means for outputting or obtaining data during the one or more on periods of the discontinuous reception cycle is based on outputting the first-stage wakeup indication.

In some examples, the energy state manager 1740 may be configured as or otherwise support a means for obtaining, prior to expiration of an inactivity timer during the one or more on periods of the discontinuous reception cycle, an indication of UE capability in a next on period of the discontinuous reception cycle.

In some examples, the energy transfer manager 1750 may be configured as or otherwise support a means for outputting an energy transfer signal during the one or more on periods of the discontinuous reception cycle and based on outputting the first-stage wakeup notification.

In some examples, the energy state manager 1740 may be configured as or otherwise support a means for obtaining, in the first-stage wakeup notification, an indication of a battery power level of the UE.

In some examples, to support obtaining the first-stage wakeup notification, the energy state manager 1740 may be configured as or otherwise support a means for obtaining the first-stage wakeup notification in a random access message, a service request, a scheduling request, a buffer status report, or a combination thereof.

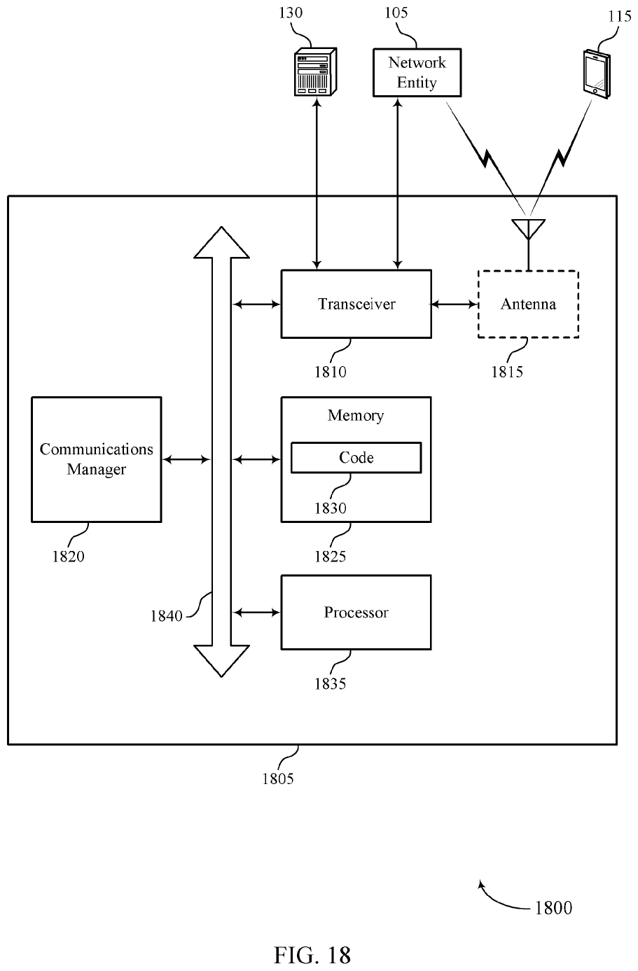

FIG. 18 shows a diagram of a system 1800 including a device 1805 that supports multi-stage wakeup signaling for passive devices in accordance with one or more aspects of the present disclosure. The device 1805 may be an example of or include the components of a device 1505, a device 1605, or a network entity 105 as described herein. The device 1805 may communicate with one or more network entities 105, one or more UEs 115, or any combination thereof, which may include communications over one or more wired interfaces, over one or more wireless interfaces, or any combination thereof. The device 1805 may include components that support outputting and obtaining communications, such as a communications manager 1820, a transceiver 1810, an antenna 1815, a memory 1825, code 1830, and a processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. The transceiver 1810, or the transceiver 1810 and one or more antennas 1815 or wired interfaces, where applicable, may be an example of a transmitter 1515, a transmitter 1615, a receiver 1510, a receiver 1610, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1825 may include RAM and ROM. The memory 1825 may store computer-readable, computer-executable code 1830 including instructions that, when executed by the processor 1835, cause the device 1805 to perform various functions described herein. The code 1830 may be stored in a non-transitory computer-readable medium such as system memory or another type of memory. In some cases, the code 1830 may not be directly executable by the processor 1835 but may cause a computer (e.g., when compiled and executed) to perform functions described herein. In some cases, the memory 1825 may contain, among other things, a BIOS which may control basic hardware or software operation such as the interaction with peripheral components or devices.

The processor 1835 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1835 may be configured to operate a memory array using a memory controller. In some other cases, a memory controller may be integrated into the processor 1835. The processor 1835 may be configured to execute computer-readable instructions stored in a memory (e.g., the memory 1825) to cause the device 1805 to perform various functions (e.g., functions or tasks supporting multi-stage wakeup signaling for passive devices). For example, the device 1805 or a component of the device 1805 may include a processor 1835 and memory 1825 coupled with the processor 1835, the processor 1835 and memory 1825 configured to perform various functions described herein. The processor 1835 may be an example of a cloud-computing platform (e.g., one or more physical nodes and supporting software such as operating systems, virtual machines, or container instances) that may host the functions (e.g., by executing code 1830) to perform the functions of the device 1805.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the memory 1825, the code 1830, and the processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with other network entities 105, and may include a controller or scheduler for controlling communications with UEs 115 in cooperation with other network entities 105. In some examples, the communications manager 1820 may support an X2 interface within an LTE/LTE-A wireless communications network technology to provide communication between network entities 105.

The communications manager 1820 may support wireless communications at a wireless device in accordance with examples as disclosed herein. For example, the communications manager 1820 may be configured as or otherwise support a means for outputting control signaling indicating resources allocated to one or more energy handshake messages of a multi-stage energy handshake protocol between the wireless device and a UE, where the one or more energy handshake messages is associated with a repetition factor and a periodicity. The communications manager 1820 may be configured as or otherwise support a means for outputting or obtaining the one or more energy handshake messages using the indicated resources and in accordance with the repetition factor and the periodicity. The communications manager 1820 may be configured as or otherwise support a means for outputting or obtaining data during one or more on periods of a discontinuous reception cycle based on the one or more energy handshake messages.

By including or configuring the communications manager 1820 in accordance with examples as described herein, the device 1805 may support techniques for energy handshake protocols resulting in reduced power consumption, improved battery life, improved communication reliability, reduced latency, improved user experience related to reduced processing, reduced power consumption, more efficient utilization of communication resources, and improved user experience.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the processor 1835, the memory 1825, the code 1830, the transceiver 1810, or any combination thereof. For example, the code 1830 may include instructions executable by the processor 1835 to cause the device 1805 to perform various aspects of multi-stage wakeup signaling for passive devices as described herein, or the processor 1835 and the memory 1825 may be otherwise configured to perform or support such operations.

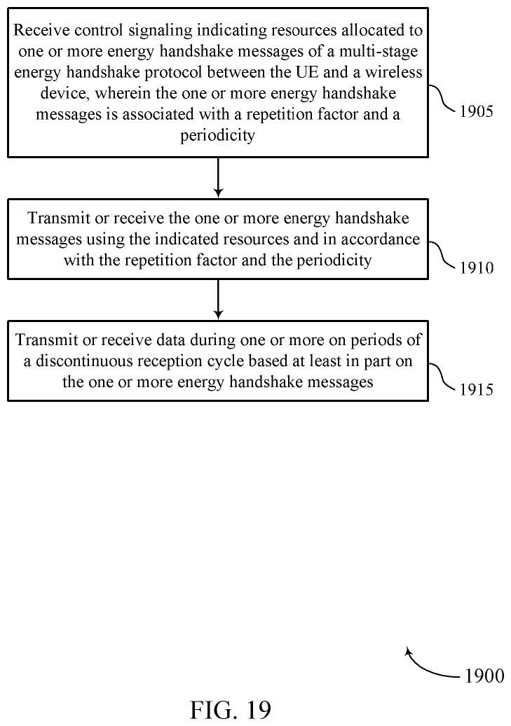

FIG. 19 shows a flowchart illustrating a method 1900 that supports multi-stage wakeup signaling for passive devices in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving control signaling indicating resources allocated to one or more energy handshake messages of a multi-stage energy handshake protocol between the UE and a wireless device, where the one or more energy handshake messages is associated with a repetition factor and a periodicity. The operations of 1905 may be performed in accordance with examples as disclosed herein. In some examples, aspects of the operations of 1905 may be performed by an energy handshake resource manager 1325 as described with reference to FIG. 13.

At 1910, the method may include transmitting or receiving the one or more energy handshake messages using the indicated resources and in accordance with the repetition factor and the periodicity. The operations of 1910 may be performed in accordance with examples as disclosed herein. In some examples, aspects of the operations of 1910 may be performed by an energy handshake message manager 1330 as described with reference to FIG. 13.

At 1915, the method may include transmitting or receiving data during one or more on periods of a discontinuous reception cycle based on the one or more energy handshake messages. The operations of 1915 may be performed in accordance with examples as disclosed herein. In some examples, aspects of the operations of 1915 may be performed by a duty cycle manager 1335 as described with reference to FIG. 13.

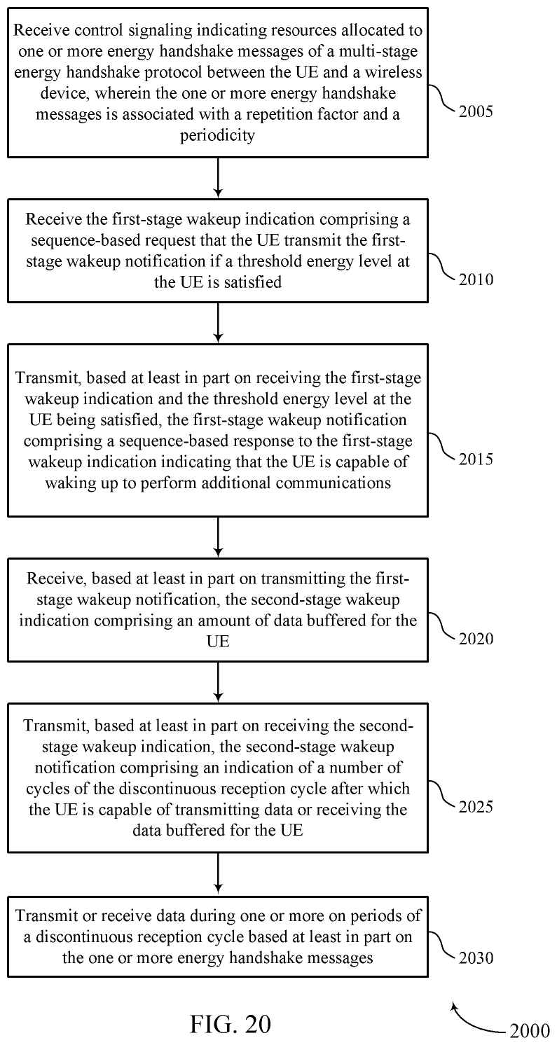

FIG. 20 shows a flowchart illustrating a method 2000 that supports multi-stage wakeup signaling for passive devices in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2005, the method may include receiving control signaling indicating resources allocated to one or more energy handshake messages of a multi-stage energy handshake protocol between the UE and a wireless device, where the one or more energy handshake messages is associated with a repetition factor and a periodicity, wherein the one or more energy handshake messages comprises a first-stage wakeup indication, a second-stage wakeup indication, a first-stage wakeup notification, and a second-stage wakeup notification. The operations of 2005 may be performed in accordance with examples as disclosed herein. In some examples, aspects of the operations of 2005 may be performed by an energy handshake resource manager 1325 as described with reference to FIG. 13.

At 2010, the method may include receiving the first-stage wakeup indication including a sequence-based request that the UE transmit the first-stage wakeup notification if a threshold energy level at the UE is satisfied. The operations of 2010 may be performed in accordance with examples as disclosed herein. In some examples, aspects of the operations of 2010 may be performed by an energy handshake message manager 1330 as described with reference to FIG. 13.

At 2015, the method may include transmitting, based on receiving the first-stage wakeup indication and the threshold energy level at the UE being satisfied, the first-stage wakeup notification including a sequence-based response to the first-stage wakeup indication indicating that the UE is capable of waking up to perform additional communications. The operations of 2015 may be performed in accordance with examples as disclosed herein. In some examples, aspects of the operations of 2015 may be performed by an energy handshake message manager 1330 as described with reference to FIG. 13.

At 2020 the method may include receiving, based on transmitting the first-stage wakeup notification, the second-stage wakeup indication including an amount of data buffered for the UE. The operations of 2020 may be performed in accordance with examples as disclosed herein. In some examples, aspects of the operations of 2020 may be performed by an energy handshake message manager 1330 as described with reference to FIG. 13.

At 2025, the method may include transmitting, based on receiving the second-stage wakeup indication, the second-stage wakeup notification including an indication of a number of cycles of the discontinuous reception cycle after which the UE is capable of transmitting data or receiving the data buffered for the UE. The operations of 2025 may be performed in accordance with examples as disclosed herein. In some examples, aspects of the operations of 2025 may be performed by an energy handshake message manager 1330 as described with reference to FIG. 13.

At 2030, the method may include transmitting or receiving data during one or more on periods of a discontinuous reception cycle based on the one or more energy handshake messages. The operations of 2030 may be performed in accordance with examples as disclosed herein. In some examples, aspects of the operations of 2030 may be performed by a duty cycle manager 1335 as described with reference to FIG. 13.

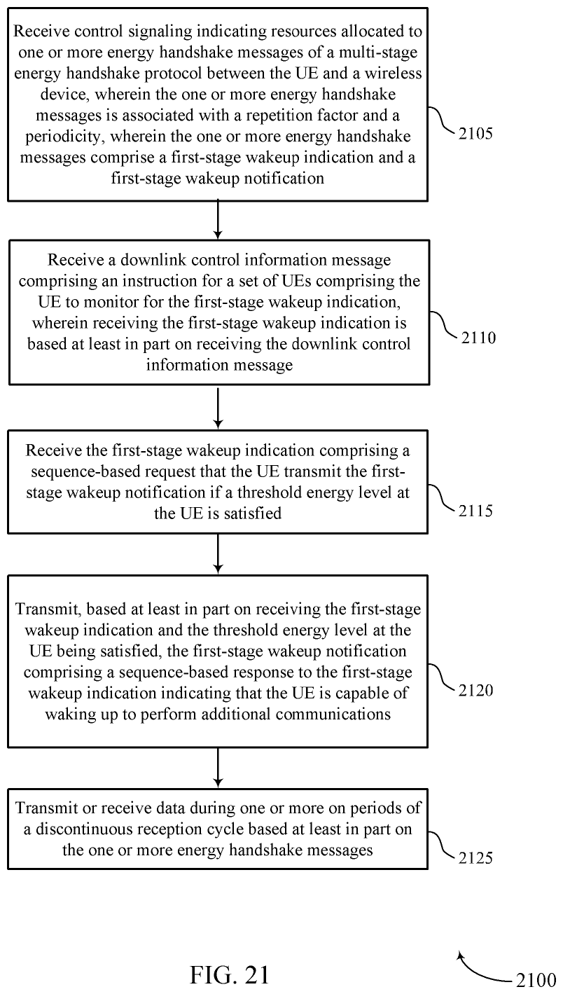

FIG. 21 shows a flowchart illustrating a method 2100 that supports multi-stage wakeup signaling for passive devices in accordance with one or more aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2105, the method may include receiving control signaling indicating resources allocated to one or more energy handshake messages of a multi-stage energy handshake protocol between the UE and a wireless device, where the one or more energy handshake messages is associated with a repetition factor and a periodicity, and wherein the one or more energy handshake messages comprise a first-stage wakeup indication and a first-stage wakeup notification. The operations of 2105 may be performed in accordance with examples as disclosed herein. In some examples, aspects of the operations of 2105 may be performed by an energy handshake resource manager 1325 as described with reference to FIG. 13.

At 2110, the method may include receiving the first-stage wakeup indication including a sequence-based request that the UE transmit the first-stage wakeup notification if a threshold energy level at the UE is satisfied. The operations of 2110 may be performed in accordance with examples as disclosed herein. In some examples, aspects of the operations of 2110 may be performed by an energy handshake message manager 1330 as described with reference to FIG. 13.

At 2115, the method may include receiving a downlink control information message including an instruction for a set of UEs including the UE to monitor for the first-stage wakeup indication, where receiving the first-stage wakeup indication is based on receiving the downlink control information message. The operations of 2115 may be performed in accordance with examples as disclosed herein. In some examples, aspects of the operations of 2115 may be performed by a DCI manager 1340 as described with reference to FIG. 13.

At 2120, the method may include transmitting, based on receiving the first-stage wakeup indication and the threshold energy level at the UE being satisfied, the first-stage wakeup notification including a sequence-based response to the first-stage wakeup indication indicating that the UE is capable of waking up to perform additional communications. The operations of 2120 may be performed in accordance with examples as disclosed herein. In some examples, aspects of the operations of 2120 may be performed by an energy handshake message manager 1330 as described with reference to FIG. 13.

At 2125, the method may include transmitting or receiving data during one or more on periods of a discontinuous reception cycle based on the one or more energy handshake messages. The operations of 2125 may be performed in accordance with examples as disclosed herein. In some examples, aspects of the operations of 2125 may be performed by a duty cycle manager 1335 as described with reference to FIG. 13.

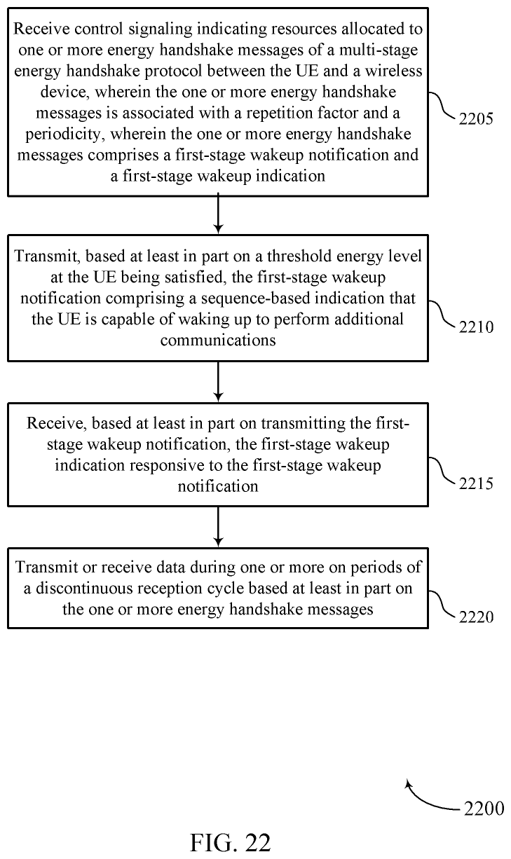

FIG. 22 shows a flowchart illustrating a method 2200 that supports multi-stage wakeup signaling for passive devices in accordance with one or more aspects of the present disclosure. The operations of the method 2200 may be implemented by a UE or its components as described herein. For example, the operations of the method 2200 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2205, the method may include receiving control signaling indicating resources allocated to one or more energy handshake messages of a multi-stage energy handshake protocol between the UE and a wireless device, where the one or more energy handshake messages is associated with a repetition factor and a periodicity, wherein the one or more energy handshake messages comprises a first-stage wakeup notification and a first-stage wakeup indication. The operations of 2205 may be performed in accordance with examples as disclosed herein. In some examples, aspects of the operations of 2205 may be performed by an energy handshake resource manager 1325 as described with reference to FIG. 13.

At 2210, the method may include transmitting, based on a threshold energy level at the UE being satisfied, the first-stage wakeup notification including a sequence-based indication that the UE is capable of waking up to perform additional communications. The operations of 2210 may be performed in accordance with examples as disclosed herein. In some examples, aspects of the operations of 2210 may be performed by an energy handshake message manager 1330 as described with reference to FIG. 13.

At 2215, the method may include receiving, based on transmitting the first-stage wakeup notification, the first-stage wakeup indication responsive to the first-stage wakeup notification. The operations of 2215 may be performed in accordance with examples as disclosed herein. In some examples, aspects of the operations of 2215 may be performed by an energy handshake message manager 1330 as described with reference to FIG. 13.

At 2220, the method may include transmitting or receiving data during one or more on periods of a discontinuous reception cycle based on the one or more energy handshake messages. The operations of 2220 may be performed in accordance with examples as disclosed herein. In some examples, aspects of the operations of 2220 may be performed by a duty cycle manager 1335 as described with reference to FIG. 13.

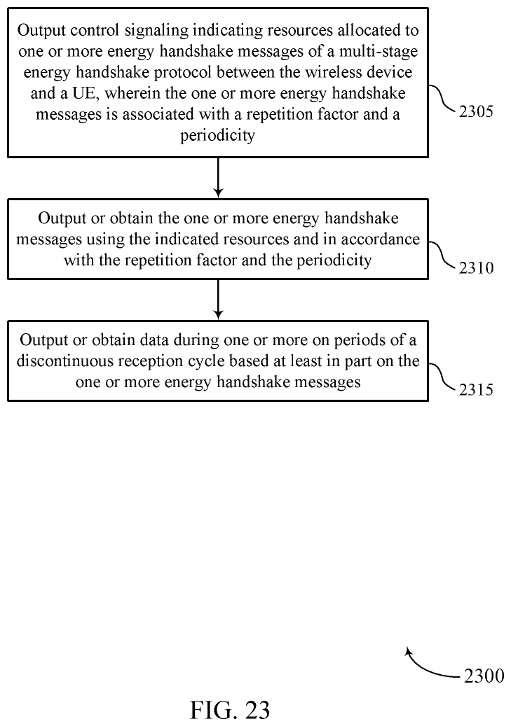

FIG. 23 shows a flowchart illustrating a method 2300 that supports multi-stage wakeup signaling for passive devices in accordance with one or more aspects of the present disclosure. The operations of the method 2300 may be implemented by a network entity or its components as described herein. For example, the operations of the method 2300 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2305, the method may include outputting control signaling indicating resources allocated to one or more energy handshake messages of a multi-stage energy handshake protocol between the wireless device and a UE, where the one or more energy handshake messages is associated with a repetition factor and a periodicity. The operations of 2305 may be performed in accordance with examples as disclosed herein. In some examples, aspects of the operations of 2305 may be performed by an energy handshake resource manager 1725 as described with reference to FIG. 17.

At 2310, the method may include outputting or obtaining the one or more energy handshake messages using the indicated resources and in accordance with the repetition factor and the periodicity. The operations of 2310 may be performed in accordance with examples as disclosed herein. In some examples, aspects of the operations of 2310 may be performed by an energy handshake message manager 1730 as described with reference to FIG. 17.

At 2315, the method may include outputting or obtaining data during one or more on periods of a discontinuous reception cycle based on the one or more energy handshake messages. The operations of 2315 may be performed in accordance with examples as disclosed herein. In some examples, aspects of the operations of 2315 may be performed by a duty cycle manager 1735 as described with reference to FIG. 17.

The following provides an overview of aspects of the present disclosure:

Aspect 1: A method for wireless communications at a UE, comprising: receiving control signaling indicating resources allocated to one or more energy handshake messages of a multi-stage energy handshake protocol between the UE and a wireless device, wherein the one or more energy handshake messages is associated with a repetition factor and a periodicity; transmitting or receiving the one or more energy handshake messages using the indicated resources and in accordance with the repetition factor and the periodicity; and transmitting or receiving data during one or more on periods of a discontinuous reception cycle based at least in part on the one or more energy handshake messages.

Aspect 2: The method of aspect 1, wherein the one or more energy handshake messages comprise a first-stage wakeup indication and a first-stage wakeup notification wherein transmitting or receiving the one or more energy handshake messages comprises: receiving the first-stage wakeup indication comprising a sequence-based request that the UE transmit the first-stage wakeup notification if a threshold energy level at the UE is satisfied; and transmitting, based at least in part on receiving the first-stage wakeup indication and the threshold energy level at the UE being satisfied, the first-stage wakeup notification comprising a sequence-based response to the first-stage wakeup indication indicating that the UE is capable of waking up to perform additional communications.

Aspect 3: The method of aspect 2, wherein the one or more energy handshake messages further comprise a second-stage wakeup indication and a second-stage wakeup notification, wherein transmitting or receiving the one or more energy handshake messages comprises: receiving, based at least in part on transmitting the first-stage wakeup notification, the second-stage wakeup indication comprising an amount of data buffered for the UE; and transmitting, based at least in part on receiving the second-stage wakeup indication, the second-stage wakeup notification comprising an indication of a number of cycles of the discontinuous reception cycle after which the UE is capable of transmitting data or receiving the data buffered for the UE.

Aspect 4: The method of aspect 3, wherein the one or more energy handshake messages further comprise a second first-stage wakeup indication, a second first-stage wakeup notification, a second second-stage wakeup indication, and a second second-stage wakeup notification wherein transmitting or receiving the one or more energy handshake messages comprises: waking up after expiration of the number of cycles of the discontinuous reception cycle; receiving a second first-stage wakeup indication; transmitting, based at least in part on receiving the second first-stage wakeup indication, a second first-stage wakeup notification comprising a sequence-based response to the second first-stage wakeup indication indicating that the UE is capable of waking up to perform additional communications; receiving, based at least in part on transmitting the second first-stage wakeup notification, a second second-stage wakeup indication; and transmitting, based at least in part on receiving the second second-stage wakeup indication, a second second-stage wakeup notification indicating that the UE is capable of receiving the data buffered for the UE or transmitting data in a next on period of the discontinuous reception cycle.

Aspect 5: The method of any of aspects 3 through 4, wherein the one or more energy handshake messages further comprise a second first-stage wakeup indication, a second first-stage wakeup notification, a second second-stage wakeup indication, and a second second-stage wakeup notification wherein transmitting or receiving the one or more energy handshake messages comprises: waking up after expiration of the number of cycles of the discontinuous reception cycle; refraining from transmitting a second first-stage wakeup notification based at least in part on transmitting the second-stage wakeup notification; receiving, based at least in part on transmitting the second-stage wakeup indication comprising the indication of the number of cycles of the discontinuous reception cycle, a second second-stage wakeup indication; and transmitting, based at least in part on receiving the second second-stage wakeup indication, a second second-stage wakeup notification indicating that the UE is capable of receiving the data buffered for the UE or transmitting data in a next on period of the discontinuous reception cycle.

Aspect 6: The method of any of aspects 3 through 5, further comprising: monitoring a set of one or more energy transfer resources for an energy transfer signal based at least in part on transmitting the second-stage wakeup notification; and performing energy harvesting using the energy transfer signal, wherein transmitting the second-stage wakeup notification is based at least in part on performing the energy harvesting.

Aspect 7: The method of any of aspects 3 through 6, further comprising: determining the number of cycles of the discontinuous reception cycle after which the UE is capable of receiving the data buffered for the UE or transmitting data based at least in part on a default time value, a battery status, a pathloss, a target power, a buffer status report, an indication of a length of time for receiving the data buffered for the UE included in the second-stage wakeup indication, or any combination thereof.

Aspect 8: The method of any of aspects 3 through 7, further comprising: including, in the second-stage wakeup notification, an indication of a threshold time gap between a first message comprising an uplink message, a downlink message, or a sidelink message, and a second message comprising a downlink message, an uplink message, or a sidelink message, wherein the threshold time gap is based at least in part on a type of channel associated with the first message, a type of channel associated with the second message, or both.

Aspect 9: The method of any of aspects 2 through 8, further comprising: receiving a downlink control information message comprising an instruction for a set of UEs comprising the UE to monitor for the first-stage wakeup indication, wherein receiving the first-stage wakeup indication is based at least in part on receiving the downlink control information message.

Aspect 10: The method of aspect 9, further comprising: decoding, in the downlink control information message, a UE identifier associated with the UE, wherein receiving the instruction for the set of UEs to monitor for the first-stage wakeup indication is based at least in part on decoding the UE identifier associated with the UE.

Aspect 11: The method of any of aspects 9 through 10, further comprising: receiving an indication of a set of resources on which the set of UEs is to monitor for the downlink control information message, wherein receiving the downlink control information message is based at least in part on monitoring the set of resources.

Aspect 12: The method of any of aspects 9 through 11, wherein the one or more energy handshake messages further comprise a second-stage wakeup notification, and the first-stage wakeup indication is multicast, and the second-stage wakeup indication is unicast

Aspect 13: The method of any of aspects 1 through 12, wherein the one or more energy handshake messages further comprise a first-stage wakeup indication, a second-stage wakeup indication, a second-stage wakeup notification, and a second first-stage wakeup indication, wherein transmitting or receiving the one or more energy handshake messages comprises: receiving the first-stage wakeup indication comprising a sequence-based request that the UE transmit a first-stage wakeup notification if a threshold energy level at the UE is satisfied; refraining from transmitting the first-stage wakeup notification based at least in part on the threshold energy level at the UE not being satisfied; and receiving the second first-stage wakeup indication after a threshold period of time based at least in part on refraining from transmitting the first-stage wakeup notification.

Aspect 14: The method of aspect 13, further comprising: receiving control signaling comprising an indication of the threshold period of time.

Aspect 15: The method of any of aspects 13 through 14, further comprising: determining the threshold period of time based at least in part on a power charging threshold sufficient for performing wireless communications during the one or more on periods of the discontinuous reception cycle.

Aspect 16: The method of any of aspects 1 through 15, further comprising: receiving a synchronization signal block corresponding to the resources allocated to the one or more energy handshake messages, wherein the control signaling indicating the resources comprises a mapping between the synchronization signal block and the resources, and wherein transmitting or receiving the one or more energy handshake messages is based at least in part on a determination of the resources based at least in part on the mapping.

Aspect 17: The method of any of aspects 1 through 16, wherein the one or more energy handshake messages comprise a first-stage wakeup indication, a first-stage wakeup notification, a second-stage wakeup indication, and a second-stage wakeup notification, further comprising: receiving, in the control signaling indicating the resources allocated to the one or more energy handshake messages, an indication of a timing offset between the first-stage wakeup indication and the first-stage wakeup notification, and the second-stage wakeup indication and the second-stage wakeup notification.

Aspect 18: The method of any of aspects 1 through 17, wherein the one or more energy handshake messages comprise a first-stage wakeup notification and a first-stage wakeup indication, wherein transmitting or receiving the one or more energy handshake messages comprises: transmitting, based at least in part on a threshold energy level at the UE being satisfied, the first-stage wakeup notification comprising a sequence-based indication that the UE is capable of waking up to perform additional communications; and receiving, based at least in part on transmitting the first-stage wakeup notification, the first-stage wakeup indication responsive to the first-stage wakeup notification.

Aspect 19: The method of aspect 18, wherein transmitting or receiving data during the one or more on periods of the discontinuous reception cycle is based at least in part on receiving the first-stage wakeup indication.

Aspect 20: The method of aspect 19, further comprising: transmitting, prior to expiration of an inactivity timer during the one or more on periods of the discontinuous reception cycle, an indication of UE capability in a next on period of the discontinuous reception cycle.

Aspect 21: The method of any of aspects 18 through 20, further comprising: receiving an energy transfer signal during the one or more on periods of the discontinuous reception cycle and based at least in part on receiving the first-stage wakeup notification.

Aspect 22: The method of any of aspects 18 through 21, further comprising: including, in the first-stage wakeup notification, an indication of a battery power level of the UE.

Aspect 23: The method of any of aspects 18 through 22, wherein transmitting the first-stage wakeup notification comprises: including the first-stage wakeup notification in a random access message, a service request, a scheduling request, a buffer status report, or a combination thereof.

Aspect 24: The method of any of aspects 1 through 23, further comprising: resetting a round trip time timer based at least in part on determining that an energy level at the UE does not satisfy a threshold or based at least in part on the UE transmitting an indication of an amount of time for harvesting an amount of energy that satisfies the threshold in one of the one or more energy handshake messages; continuing the round trip time timer during a next on period of the one or more on periods of the discontinuous reception cycle.

Aspect 25: A method for wireless communications at a wireless device, comprising: outputting control signaling indicating resources allocated to one or more energy handshake messages of a multi-stage energy handshake protocol between the wireless device and a UE, wherein the one or more energy handshake messages is associated with a repetition factor and a periodicity; outputting or obtaining the one or more energy handshake messages using the indicated resources and in accordance with the repetition factor and the periodicity; and outputting or obtaining data during one or more on periods of a discontinuous reception cycle based at least in part on the one or more energy handshake messages.

Aspect 26: The method of aspect 25, wherein the one or more energy handshake messages comprise a first-stage wakeup indication and a first-stage wakeup notification wherein outputting or obtaining the one or more energy handshake messages comprises: outputting the first-stage wakeup indication comprising a sequence-based request that the UE transmit the first-stage wakeup notification if a threshold energy level at the UE is satisfied; and obtaining, based at least in part on outputting the first-stage wakeup indication and the threshold energy level at the UE being satisfied, the first-stage wakeup notification comprising a sequence-based response to the first-stage wakeup indication indicating that the UE is capable of waking up to perform additional communications.

Aspect 27: The method of aspect 26, wherein the one or more energy handshake messages further comprise a second-stage wakeup indication and a second-stage wakeup notification, wherein outputting or obtaining the one or more energy handshake messages comprises: outputting, based at least in part on obtaining the first-stage wakeup notification, the second-stage wakeup indication comprising an amount of data buffered for the UE; and obtaining, based at least in part on outputting the second-stage wakeup indication, the second-stage wakeup notification comprising an indication of a number of cycles of the discontinuous reception cycle after which the UE is capable of transmitting data or receiving the data buffered for the UE.

Aspect 28: The method of aspect 27, wherein the one or more energy handshake messages further comprise a second first-stage wakeup indication, a second first-stage wakeup notification, a second second-stage wakeup indication, and a second second-stage wakeup notification wherein outputting or obtaining the one or more energy handshake messages comprises: outputting the second first-stage wakeup indication upon expiration of the number cycles of the discontinuous reception cycle; obtaining, based at least in part on outputting the second first-stage wakeup indication, a second first-stage wakeup notification comprising a sequence-based response to the second first-stage wakeup indication indicating that the UE is capable of waking up to perform additional communications; outputting, based at least in part on obtaining the second first-stage wakeup notification, a second second-stage wakeup indication; and obtaining, based at least in part on outputting the second second-stage wakeup indication, a second second-stage wakeup notification indicating that the UE is capable of receiving the data buffered for the UE or transmitting data in a next on period of the discontinuous reception cycle.

Aspect 29: The method of any of aspects 27 through 28, wherein the one or more energy handshake messages further comprise a second second-stage wakeup indication, and a second second-stage wakeup notification wherein outputting or obtaining the one or more energy handshake messages comprises: outputting, upon expiration of the number of cycles of the discontinuous reception cycle and based at least in part on obtaining the second-stage wakeup notification, a second second-stage wakeup indication; and obtaining, based at least in part on outputting the second second-stage wakeup indication, a second second-stage wakeup notification indicating that the UE is capable of receiving the data buffered for the UE or transmitting data in a next on period of the discontinuous reception cycle.

Aspect 30: The method of any of aspects 27 through 29, further comprising: outputting, via a set of one or more energy transfer resources, an energy transfer signal based at least in part on obtaining the second-stage wakeup notification.

Aspect 31: The method of any of aspects 27 through 30, wherein the number of cycles of the discontinuous reception cycles is based at least in part on a default time value, a battery status, a pathloss, a target power, a buffer status report, an indication of a length of time for receiving the data buffered for the UE included in the second-stage wakeup indication, or any combination thereof.

Aspect 32: The method of any of aspects 27 through 31, further comprising: obtaining, in the second-stage wakeup notification, an indication of a threshold time gap between a first transmission and a second transmission, wherein the first transmission comprises a downlink transmissions, an uplink transmissions, or a sidelink transmission, and wherein the second transmission comprises a downlink transmission, an uplink transmission, or a sidelink transmission.

Aspect 33: The method of any of aspects 26 through 32, further comprising: outputting a downlink control information message comprising an instruction for a set of UEs comprising the UE to monitor for the first-stage wakeup indication, wherein outputting the first-stage wakeup indication is based at least in part on outputting the downlink control information message.

Aspect 34: The method of aspect 33, further comprising: including, in the downlink control information message, a set of UE identifiers for the set of UEs, the set of UE identifiers comprising a UE identifier associated with the UE.

Aspect 35: The method of any of aspects 33 through 34, further comprising: outputting an indication of a set of resources on which the set of UEs is to monitor for the downlink control information message.

Aspect 36: The method of any of aspects 33 through 35, wherein the one or more energy handshake messages further comprise a second-stage wakeup notification, and the first-stage wakeup indication is multicast, and the second-stage wakeup indication is unicast

Aspect 37: The method of any of aspects 25 through 36, wherein the one or more energy handshake messages further comprise a first-stage wakeup indication, a second-stage wakeup indication, a second-stage wakeup notification, and a second first-stage wakeup indication, wherein transmitting or receiving the one or more energy handshake messages comprises: outputting the first-stage wakeup indication comprising a sequence-based request that the UE transmit a first-stage wakeup notification if a threshold energy level at the UE is satisfied; monitoring for the first-stage wakeup notification based at least in part on outputting the first-stage wakeup indication; and outputting a second first-stage wakeup indication after a threshold period of time based at least in part on the monitoring.

Aspect 38: The method of aspect 37, further comprising: outputting control signaling comprising an indication of the threshold period of time.

Aspect 39: The method of any of aspects 37 through 38, further comprising: determining the threshold period of time based at least in part on a power charging threshold sufficient for performing wireless communications during the one or more on periods of the discontinuous reception cycle.

Aspect 40: The method of any of aspects 25 through 39, further comprising: outputting a synchronization signal block corresponding to the resources allocated to the one or more energy handshake messages, wherein the control signaling indicating the resources comprises a mapping between the synchronization signal block and the resources, and wherein outputting or obtaining the one or more energy handshake messages is based at least in part on a determination of the resources based at least in part on the mapping.

Aspect 41: The method of any of aspects 25 through 40, wherein the one or more energy handshake messages comprise a first-stage wakeup indication, a first-stage wakeup notification, a second-stage wakeup indication, and a second-stage wakeup notification, further comprising: outputting, in the control signaling indicating the resources allocated to the one or more energy handshake messages, an indication of a timing offset between the first-stage wakeup indication and the first-stage wakeup notification, and the second-stage wakeup indication and the second-stage wakeup notification.

Aspect 42: The method of any of aspects 25 through 41, wherein the one or more energy handshake messages comprise a first-stage wakeup notification and a first-stage wakeup indication, wherein outputting or obtaining the one or more energy handshake messages comprises: obtaining, based at least in part on a threshold energy level at the UE being satisfied, the first-stage wakeup notification comprising a sequence-based indication that the UE is capable of waking up to perform additional communications; and outputting, based at least in part on obtaining the first-stage wakeup notification, the first-stage wakeup indication responsive to the first-stage wakeup notification.

Aspect 43: The method of aspect 42, further comprising: outputting or obtaining data during the one or more on periods of the discontinuous reception cycle is based at least in part on outputting the first-stage wakeup indication.

Aspect 44: The method of aspect 43, further comprising: obtaining, prior to expiration of an inactivity timer during the one or more on periods of the discontinuous reception cycle, an indication of UE capability in a next on period of the discontinuous reception cycle.

Aspect 45: The method of any of aspects 42 through 44, further comprising: outputting an energy transfer signal during the one or more on periods of the discontinuous reception cycle and based at least in part on outputting the first-stage wakeup notification.

Aspect 46: The method of any of aspects 42 through 45, further comprising: obtaining, in the first-stage wakeup notification, an indication of a battery power level of the UE.

Aspect 47: The method of any of aspects 42 through 46, wherein obtaining the first-stage wakeup notification comprises: obtaining the first-stage wakeup notification in a random access message, a service request, a scheduling request, a buffer status report, or a combination thereof.

Aspect 48: An apparatus for wireless communications at a UE, comprising at least one processor; and memory coupled to the at least one processor, the memory storing instructions executable by the at least one processor to cause the UE to perform a method of any of aspects 1 through 24.

Aspect 49: An apparatus for wireless communications at a UE, comprising at least one means for performing a method of any of aspects 1 through 24.

Aspect 50: A non-transitory computer-readable medium storing code for wireless communications at a UE, the code comprising instructions executable by a processor to perform a method of any of aspects 1 through 24.

Aspect 51: An apparatus for wireless communications at a wireless device, comprising at least one processor; and memory coupled to the at least one processor, the memory storing instructions executable by the processor to cause the wireless device to perform a method of any of aspects 25 through 47.

Aspect 52: An apparatus for wireless communications at a wireless device, comprising at least one means for performing a method of any of aspects 25 through 47.

Aspect 53: A non-transitory computer-readable medium storing code for wireless communications at a wireless device, the code comprising instructions executable by a processor to perform a method of any of aspects 25 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, obtaining, selecting, choosing, or establishing.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled to the at least one processor, the memory storing instructions executable by the at least one processor to cause the UE to:
receive control signaling indicating resources allocated to one or more energy handshake messages of a multi-stage energy handshake protocol between the UE and a wireless device, wherein the one or more energy handshake messages is associated with a repetition factor and a periodicity;
transmit or receive the one or more energy handshake messages using the indicated resources and in accordance with the repetition factor and the periodicity; and
transmit or receive data during one or more on periods of a discontinuous reception cycle based at least in part on the one or more energy handshake messages.

2. The apparatus of claim 1, wherein the one or more energy handshake messages comprise a first-stage wakeup indication and a first-stage wakeup notification, and wherein the instructions to transmit or receive the one or more energy handshake messages are executable by the at least one processor to cause the UE to:
receive the first-stage wakeup indication comprising a sequence-based request that the UE transmit the first-stage wakeup notification if a threshold energy level at the UE is satisfied; and
transmit, based at least in part on receiving the first-stage wakeup indication and the threshold energy level at the UE being satisfied, the first-stage wakeup notification comprising a sequence-based response to the first-stage wakeup indication indicating that the UE is capable of waking up to perform additional communications.

3. The apparatus of claim 2, wherein the one or more energy handshake messages further comprise a second-stage wakeup indication and a second-stage wakeup notification, wherein the instructions to transmit or receive the one or more energy handshake messages are executable by the at least one processor to cause the UE to:
receive, based at least in part on transmitting the first-stage wakeup notification, the second-stage wakeup indication comprising an amount of data buffered for the UE; and
transmit, based at least in part on receiving the second-stage wakeup indication, the second-stage wakeup notification comprising an indication of a number of cycles of the discontinuous reception cycle after which the UE is capable of transmitting data or receiving the data buffered for the UE.

4. The apparatus of claim 3, wherein the one or more energy handshake messages further comprise a second first-stage wakeup indication, a second first-stage wakeup notification, a second second-stage wakeup indication, and a second second-stage wakeup notification, and wherein the instructions to transmit or receive the one or more energy handshake messages are executable by the at least one processor to cause the UE to:
wake up after expiration of the number of cycles of the discontinuous reception cycle;
receive a second first-stage wakeup indication;
transmit, based at least in part on receiving the second first-stage wakeup indication, a second first-stage wakeup notification comprising a sequence-based response to the second first-stage wakeup indication indicating that the UE is capable of waking up to perform additional communications;
receive, based at least in part on transmitting the second first-stage wakeup notification, a second second-stage wakeup indication; and
transmit, based at least in part on receiving the second second-stage wakeup indication, a second second-stage wakeup notification indicating that the UE is capable of receiving the data buffered for the UE or transmitting data in a next on period of the discontinuous reception cycle.

5. The apparatus of claim 3, wherein the one or more energy handshake messages further comprise a second first-stage wakeup indication, a second first-stage wakeup notification, a second second-stage wakeup indication, and a second second-stage wakeup notification, and wherein the instructions to transmit or receive the one or more energy handshake messages are executable by the at least one processor to cause the UE to:
wake up after expiration of the number of cycles of the discontinuous reception cycle;
refrain from transmitting a second first-stage wakeup notification based at least in part on transmitting the second-stage wakeup notification;
receive, based at least in part on transmitting the second-stage wakeup indication comprising the indication of the number of cycles of the discontinuous reception cycle, a second second-stage wakeup indication; and
transmit, based at least in part on receiving the second second-stage wakeup indication, a second second-stage wakeup notification indicating that the UE is capable of receiving the data buffered for the UE or transmitting data in a next on period of the discontinuous reception cycle.

6. The apparatus of claim 3, wherein the instructions are further executable by the at least one processor to cause the UE to:
monitor a set of one or more energy transfer resources for an energy transfer signal based at least in part on transmitting the second-stage wakeup notification; and
perform energy harvesting using the energy transfer signal, wherein transmitting the second-stage wakeup notification is based at least in part on performing the energy harvesting.

7. The apparatus of claim 3, wherein the instructions are further executable by the at least one processor to cause the UE to:
determine the number of cycles of the discontinuous reception cycle after which the UE is capable of receiving the data buffered for the UE or transmitting data based at least in part on a default time value, a battery status, a pathloss, a target power, a buffer status report, an indication of a length of time for receiving the data buffered for the UE included in the second-stage wakeup indication, or any combination thereof.

8. The apparatus of claim 3, wherein the instructions are further executable by the at least one processor to cause the UE to:
include, in the second-stage wakeup notification, an indication of a threshold time gap between a first message comprising an uplink message, a downlink message, or a sidelink message, and a second message comprising a downlink message, an uplink message, or a sidelink message, wherein the threshold time gap is based at least in part on a type of channel associated with the first message, a type of channel associated with the second message, or both.

9. The apparatus of claim 2, wherein the instructions are further executable by the at least one processor to cause the UE to:
receive a downlink control information message comprising an instruction for a set of UEs comprising the UE to monitor for the first-stage wakeup indication, wherein receiving the first-stage wakeup indication is based at least in part on receiving the downlink control information message.

10. The apparatus of claim 9, wherein the instructions are further executable by the at least one processor to cause the UE to:
decode, in the downlink control information message, a UE identifier associated with the UE, wherein receiving the instruction for the set of UEs to monitor for the first-stage wakeup indication is based at least in part on decoding the UE identifier associated with the UE.

11. The apparatus of claim 9, wherein the instructions are further executable by the at least one processor to cause the UE to:
receive an indication of a set of resources on which the set of UEs is to monitor for the downlink control information message, wherein receiving the downlink control information message is based at least in part on monitoring the set of resources.

12. The apparatus of claim 9, wherein the one or more energy handshake messages further comprise a second-stage wakeup indication, and wherein:
the first-stage wakeup indication is multicast, and the second-stage wakeup indication is unicast.

13. The apparatus of claim 1, wherein the one or more energy handshake messages further comprise a first-stage wakeup indication, a second-stage wakeup indication, a second-stage wakeup notification, and a second first-stage wakeup indication, and wherein the instructions to transmit or receive the one or more energy handshake messages are executable by the at least one processor to cause the UE to:
receive the first-stage wakeup indication comprising a sequence-based request that the UE transmit a first-stage wakeup notification if a threshold energy level at the UE is satisfied;
refrain from transmitting the first-stage wakeup notification based at least in part on the threshold energy level at the UE not being satisfied; and
receive the second first-stage wakeup indication after a threshold period of time based at least in part on refraining from transmitting the first-stage wakeup notification.

14. The apparatus of claim 13, wherein the instructions are further executable by the at least one processor to cause the UE to:
receive control signaling comprising an indication of the threshold period of time.

15. The apparatus of claim 13, wherein the instructions are further executable by the at least one processor to cause the UE to:
determine the threshold period of time based at least in part on a power charging threshold sufficient for performing wireless communications during the one or more on periods of the discontinuous reception cycle.

16. The apparatus of claim 1, wherein the instructions are further executable by the at least one processor to cause the UE to:
receive a synchronization signal block corresponding to the resources allocated to the one or more energy handshake messages, wherein the control signaling indicating the resources comprises a mapping between the synchronization signal block and the resources, and wherein transmitting or receiving the one or more energy handshake messages is based at least in part on a determination of the resources based at least in part on the mapping.

17. The apparatus of claim 1, wherein the one or more energy handshake messages comprise a first-stage wakeup indication, a first-stage wakeup notification, a second-stage wakeup indication, and a second-stage wakeup notification, and wherein the instructions are further executable by the at least one processor to cause the UE to:
receive, in the control signaling indicating the resources allocated to the one or more energy handshake messages, an indication of a timing offset between the first-stage wakeup indication and the first-stage wakeup notification, and the second-stage wakeup indication and the second-stage wakeup notification.

18. The apparatus of claim 1, wherein the one or more energy handshake messages comprise a first-stage wakeup notification and a first-stage wakeup indication, wherein the instructions to transmit or receive the one or more energy handshake messages are executable by the at least one processor to cause the UE to:
transmit, based at least in part on a threshold energy level at the UE being satisfied, the first-stage wakeup notification comprising a sequence-based indication that the UE is capable of waking up to perform additional communications; and
receive, based at least in part on transmitting the first-stage wakeup notification, the first-stage wakeup indication responsive to the first-stage wakeup notification.

19. The apparatus of claim 18, wherein transmitting or receiving data during the one or more on periods of the discontinuous reception cycle is based at least in part on receiving the first-stage wakeup indication.

20. The apparatus of claim 19, wherein the instructions are further executable by the at least one processor to cause the UE to:
transmit, prior to expiration of an inactivity timer during the one or more on periods of the discontinuous reception cycle, an indication of UE capability in a next on period of the discontinuous reception cycle.

21. The apparatus of claim 18, wherein the instructions are further executable by the at least one processor to cause the UE to:
receive an energy transfer signal during the one or more on periods of the discontinuous reception cycle and based at least in part on receiving the first-stage wakeup notification.

22. The apparatus of claim 18, wherein the instructions are further executable by the at least one processor to cause the UE to:
include, in the first-stage wakeup notification, an indication of a battery power level of the UE.

23. The apparatus of claim 18, wherein the instructions to transmit the first-stage wakeup notification are executable by the at least one processor to cause the UE to:
include the first-stage wakeup notification in a random access message, a service request, a scheduling request, a buffer status report, or a combination thereof.

24. An apparatus for wireless communications at a wireless device, comprising:
at least one processor; and
memory coupled to the at least one processor, the memory storing instructions executable by the at least one processor to cause the wireless device to:
output control signaling indicating resources allocated to one or more energy handshake messages of a multi-stage energy handshake protocol between the wireless device and a user equipment (UE), wherein the one or more energy handshake messages is associated with a repetition factor and a periodicity;
output or obtain the one or more energy handshake messages using the indicated resources and in accordance with the repetition factor and the periodicity; and
output or obtain data during one or more on periods of a discontinuous reception cycle based at least in part on the one or more energy handshake messages.

25. The apparatus of claim 24, wherein the one or more energy handshake messages comprise a first-stage wakeup indication and a first-stage wakeup notification, wherein the instructions to output or obtain the one or more energy handshake messages are executable by the at least one processor to cause the wireless device to:
output the first-stage wakeup indication comprising a sequence-based request that the UE transmit the first-stage wakeup notification if a threshold energy level at the UE is satisfied; and
obtain, based at least in part on outputting the first-stage wakeup indication and the threshold energy level at the UE being satisfied, the first-stage wakeup notification comprising a sequence-based response to the first-stage wakeup indication indicating that the UE is capable of waking up to perform additional communications.

26. The apparatus of claim 25, wherein the one or more energy handshake messages further comprise a second-stage wakeup indication and a second-stage wakeup notification, wherein the instructions to output or obtain the one or more energy handshake messages are executable by the at least one processor to cause the wireless device to:
output, based at least in part on obtaining the first-stage wakeup notification, the second-stage wakeup indication comprising an amount of data buffered for the UE; and
obtain, based at least in part on outputting the second-stage wakeup indication, the second-stage wakeup notification comprising an indication of a number of cycles of the discontinuous reception cycle after which the UE is capable of transmitting data or receiving the data buffered for the UE.

27. The apparatus of claim 25, wherein the instructions are further executable by the at least one processor to cause the wireless device to:
output a downlink control information message comprising an instruction for a set of UEs comprising the UE to monitor for the first-stage wakeup indication, wherein outputting the first-stage wakeup indication is based at least in part on outputting the downlink control information message.

28. The apparatus of claim 24, wherein the one or more energy handshake messages further comprise a first-stage wakeup indication, a second-stage wakeup indication, a second-stage wakeup notification, and a second first-stage wakeup indication, wherein the instructions to transmit or receive the one or more energy handshake messages are executable by the at least one processor to cause the wireless device to:
output the first-stage wakeup indication comprising a sequence-based request that the UE transmit a first-stage wakeup notification if a threshold energy level at the UE is satisfied;
monitor for the first-stage wakeup notification based at least in part on outputting the first-stage wakeup indication; and
output a second first-stage wakeup indication after a threshold period of time based at least in part on the monitoring.

29. A method for wireless communications at a user equipment (UE), comprising:
receiving control signaling indicating resources allocated to one or more energy handshake messages of a multi-stage energy handshake protocol between the UE and a wireless device, wherein the one or more energy handshake messages is associated with a repetition factor and a periodicity;
transmitting or receiving the one or more energy handshake messages using the indicated resources and in accordance with the repetition factor and the periodicity; and
transmitting or receiving data during one or more on periods of a discontinuous reception cycle based at least in part on the one or more energy handshake messages.

30. A method for wireless communications at a wireless device, comprising:
outputting control signaling indicating resources allocated to one or more energy handshake messages of a multi-stage energy handshake protocol between the wireless device and a user equipment (UE), wherein the one or more energy handshake messages is associated with a repetition factor and a periodicity;
outputting or obtaining the one or more energy handshake messages using the indicated resources and in accordance with the repetition factor and the periodicity; and
outputting or obtaining data during one or more on periods of a discontinuous reception cycle based at least in part on the one or more energy handshake messages.
